(19) United States
(12) Patent Application Publication
(10) Pub. No.: US 2025/0142628 A1
(43) Pub. Date: May 1, 2025

(54) CROSS-CARRIER RACH TRANSMISSIONS FOR INTER-BAND CARRIER AGGREGATION WITH SSB-LESS CARRIERS

(71) Applicant: QUALCOMM INCORPORATED, San Diego, CA (US)

(72) Inventors: Hung Dinh Ly, San Diego, CA (US); Kexin Xiao, Shanghai (CN)

(21) Appl. No.: 18/836,518

(22) PCT Filed: Apr. 13, 2022
(86) PCT No.: PCT/CN2022/086537

§ 371 Date: Aug. 7, 2024

(51) Int. Cl. H04W 74/0833; H04L 5/00

(52) U.S. Cl. CPC H04W 74/0833; H04L 5/001

(57) ABSTRACT

Methods, systems, and devices for wireless communications are described. A user equipment (UE) may receive a first message that indicates an inter-band carrier aggregation configuration. The inter-band carrier aggregation configuration may identify a set of carriers for carrier aggregation communication between the UE and a network entity. The UE may receive a second message that indicates a random access procedure configuration. The random access procedure configuration may include a rule pertaining to whether RACH messages may be transmitted over multiple carriers, a mapping of multiple of RACH occasions to at least one SSB index, and a repetition number that indicates a quantity of RACH message repetitions for transmission by the UE. The UE may transmit the quantity of RACH message repetitions based on the mapping. The quantity of RACH messages may be transmitted over one carrier or over the multiple carriers of the set of carriers based on the rule.

### CROSS REFERENCE

The present Application is a 371 national stage filing of International PCT Application No. PCT/CN2022/086537 by Ly et al. entitled “CROSS-CARRIER RACH TRANSMISSIONS FOR INTER-BAND CARRIER AGGREGATION WITH SSB-LESS CARRIERS,” filed Apr. 13, 2022, which is assigned to the assignee hereof, and which is expressly incorporated by reference in its entirety herein.

### FIELD OF TECHNOLOGY

The following relates to wireless communications, including cross-carrier random access channel (RACH) transmissions for inter-band carrier aggregation with synchronization signal block (SSB)-less carriers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support carrier aggregation, in which multiple carriers may be combined into a single data channel to increase the data capacity of a communications network. In some cases, existing carrier aggregation techniques may be deficient.

### SUMMARY

The described techniques relate to improved methods, systems, devices, and apparatuses that support cross-carrier random access channel (RACH) transmissions for inter-band carrier aggregation with synchronization signal block (SSB)-less carriers. For example, the described techniques provide for configuration of a communication device (e.g., a user equipment (UE)) with one or more rules for performing carrier aggregation with SSB-less carriers. In some examples, the UE may receive a first message that includes first information indicative of an inter-band carrier aggregation configuration. The inter-band carrier aggregation configuration may identify a set of carriers for carrier aggregation communication between the UE and a network entity. The UE may receive a second message that includes second information indicative of a random access procedure configuration. The random access procedure configuration may include a rule pertaining to whether RACH messages may be transmitted over multiple carriers, a mapping of multiple of RACH occasions to at least one SSB index, and a repetition number that indicates a quantity of RACH message repetitions for transmission by the UE. The UE may transmit the quantity of RACH message repetitions based on the mapping. The quantity of RACH messages may be transmitted over one carrier or over the multiple carriers of the set of carriers based on the rule. As a result, the UE may reduce power consumption and increase resource utilization within the wireless communications system.

A method for wireless communication at a UE is described. The method may include receiving a first message that includes first information indicative of an inter-band carrier aggregation configuration that identifies a set of carriers for carrier aggregation communication between the UE and a network entity, receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE, and transmitting the quantity of RACH message repetitions based on the mapping, where the quantity of RACH messages are transmitted over one carrier or over the multiple carriers of the set of carriers is based on the rule.

An apparatus for wireless communication is described. The apparatus may include a processor, memory coupled with the processor, and instructions stored in the memory. The instructions may be executable by the processor to cause the apparatus to receive a first message that includes first information indicative of an inter-band carrier aggregation configuration that identifies a set of carriers for carrier aggregation communication between the UE and a network entity, receive a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE, and transmit the quantity of RACH message repetitions based on the mapping, where the quantity of RACH messages are transmitted over one carrier or over the multiple carriers of the set of carriers is based on the rule.

Another apparatus for wireless communication is described. The apparatus may include means for receiving a first message that includes first information indicative of an inter-band carrier aggregation configuration that identifies a set of carriers for carrier aggregation communication between the UE and a network entity, means for receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE, and means for transmitting the quantity of RACH message repetitions based on the mapping, where the quantity of RACH messages are transmitted over one carrier or over the multiple carriers of the set of carriers is based on the rule.

A non-transitory computer-readable medium storing code for wireless communication at a UE is described. The code may include instructions executable by a processor to receive a first message that includes first information indicative of an inter-band carrier aggregation configuration that identifies a set of carriers for carrier aggregation communication between the UE and a network entity, receive a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE, and transmit the quantity of RACH message repetitions based on the mapping, where the quantity of RACH messages are transmitted over one carrier or over the multiple carriers of the set of carriers is based on the rule.

In some examples of the method, apparatuses, and non-transitory computer-readable medium described herein, transmitting the quantity of RACH message repetitions may include operations, features, means, or instructions for transmitting the quantity of RACH message repetitions over the one carrier in accordance with the rule.

In some examples of the method, apparatuses, and non-transitory computer-readable medium described herein, the one carrier includes a non-anchor carrier.

In some examples of the method, apparatuses, and non-transitory computer-readable medium described herein, transmitting the quantity of RACH message repetitions may include operations, features, means, or instructions for transmitting a first portion of the quantity of RACH message repetitions over the one carrier during a first association period and a second portion of the quantity of RACH message repetitions over the one carrier during a second association period, the second association period occurring subsequent to the first association period.

In some examples of the method, apparatuses, and non-transitory computer-readable medium described herein, transmitting the quantity of RACH message repetitions may include operations, features, means, or instructions for transmitting the quantity of RACH message repetitions over at least two carriers of the multiple carriers in accordance with the rule.

In some examples of the method, apparatuses, and non-transitory computer-readable medium described herein, the at least two carriers include at least one non-anchor carrier.

Some examples of the method, apparatuses, and non-transitory computer-readable medium described herein may further include operations, features, means, or instructions for transmitting a first portion of the quantity of RACH message repetitions over a first carrier of the at least two carriers and a second portion of the quantity of RACH message repetitions over a second carrier of the at least two carriers, where the second portion of the quantity of RACH message repetitions may be transmitted simultaneously with or subsequent to the first portion of the quantity of RACH message repetitions.

In some examples of the method, apparatuses, and non-transitory computer-readable medium described herein, transmitting the first portion of the quantity of RACH message repetitions over the first carrier and the second portion of the quantity of RACH message repetitions over the second carrier may include operations, features, means, or instructions for transmitting the first portion of the quantity of RACH message repetitions over the first carrier using a first spatial filter and the second portion of the quantity of RACH message repetitions over the second carrier using a second spatial filter, the second spatial filter being a same spatial filter as the first spatial filter or a different spatial filter from the first spatial filter.

In some examples of the method, apparatuses, and non-transitory computer-readable medium described herein, transmitting the first portion of the quantity of RACH message repetitions over the first carrier and the second portion of the quantity of RACH message repetitions over the second carrier may include operations, features, means, or instructions for transmitting the second portion of the quantity of RACH message repetitions subsequent to the first portion of the quantity of RACH message repetitions based on an ordering of the quantity of RACH message repetitions, where the ordering of the quantity of RACH message repetitions corresponds to the mapping of the set of multiple RACH occasions to the at least one SSB index.

In some examples of the method, apparatuses, and non-transitory computer-readable medium described herein, transmitting the quantity of RACH message repetitions may include operations, features, means, or instructions for transmitting the quantity of RACH message repetitions over at least one carrier of the multiple carriers in accordance with the rule and a sequential ordering of the quantity of RACH message repetitions, where the sequential ordering of the quantity of RACH message repetitions corresponds to the mapping of the set of multiple RACH occasions to the at least one SSB index.

In some examples of the method, apparatuses, and non-transitory computer-readable medium described herein, transmitting the quantity of RACH message repetitions may include operations, features, means, or instructions for transmitting a first RACH message repetition of the quantity of RACH message repetitions during a first RACH occasion and over a first carrier of the multiple carriers in accordance with the rule, where the first RACH occasion may be associated with a lowest RACH identifier of a set of RACH identifiers for the set of multiple RACH occasions, and where the first carrier may be associated with a lowest frequency radio frequency band or a highest frequency radio frequency band of a set of radio frequency bands for transmitting the quantity of RACH message repetitions.

In some examples of the method, apparatuses, and non-transitory computer-readable medium described herein, transmitting the quantity of RACH message repetitions may include operations, features, means, or instructions for receiving a third message that includes third information indicative of a radio frequency band for transmitting RACH message repetitions of the quantity of RACH message repetitions and transmitting a first RACH message repetition of the quantity of RACH message repetitions during a first RACH occasion and over a first carrier of the multiple carriers in accordance with the rule, where the first RACH occasion may be associated with a lowest RACH identifier of a set of RACH identifiers for the set of multiple RACH occasions, and where the first carrier may be associated with the radio frequency band indicated by the third message.

### BRIEF DESCRIPTION OF THE DRAWINGS

FIGS. 1 and 2A each illustrate an example of a wireless communications system that supports cross-carrier random access channel (RACH) transmissions for inter-band carrier aggregation with synchronization signal block (SSB)-less carriers in accordance with one or more aspects of the present disclosure.

FIG. 2B illustrates an example of a transmission scheme that supports cross-carrier RACH transmissions for inter-band carrier aggregation with SSB-less carriers in accordance with one or more aspects of the present disclosure.

FIGS. 3-7 each illustrate an example of a timing diagram that supports cross-carrier RACH transmissions for inter-band carrier aggregation with SSB-less carriers in accordance with one or more aspects of the present disclosure.

FIG. 8 illustrates an example of a process flow that supports cross-carrier RACH transmissions for inter-band carrier aggregation with SSB-less carriers in accordance with one or more aspects of the present disclosure.

FIGS. 9 and 10 show block diagrams of devices that support cross-carrier RACH transmissions for inter-band carrier aggregation with SSB-less carriers in accordance with one or more aspects of the present disclosure.

FIG. 11 shows a block diagram of a communications manager that supports cross-carrier RACH transmissions for inter-band carrier aggregation with SSB-less carriers in accordance with one or more aspects of the present disclosure.

FIG. 12 shows a diagram of a system including a device that supports cross-carrier RACH transmissions for inter-band carrier aggregation with SSB-less carriers in accordance with one or more aspects of the present disclosure.

FIGS. 13 through 15 show flowcharts illustrating methods that support cross-carrier RACH transmissions for inter-band carrier aggregation with SSB-less carriers in accordance with one or more aspects of the present disclosure.

### DETAILED DESCRIPTION

A wireless communications system may include communication devices, such as a user equipment (UE) or one or more network entities. A network entity may be an example of a wired or wireless network node that may support one or multiple radio access technologies. Examples of radio access technologies may include fourth generation (4G) systems, such as LTE systems, and fifth generation (5G) systems, which may be referred to as 5G new radio (NR) systems, among other wireless communications systems (e.g., subsequent generations of wireless communications systems) or one or more other network entities. A communication device may support wireless communication over one or multiple radio frequency bands and one or multiple carriers. In some examples, the network (e.g., one or more network entities) may schedule the communication device with a single carrier or with multiple carriers to support the wireless communication, for example in the form of carrier aggregation or dual connectivity.

In some examples, to increase the data capacity of the wireless communications system, the network may configure the communication device to support carrier aggregation over a single radio frequency band or multiple radio frequency bands (e.g., inter-band carrier aggregation). For example, the network may configure the communication device to aggregate two or more carriers across a same radio frequency band or between multiple (e.g., separate) radio frequency bands. In some examples of inter-band carrier aggregation, one of the multiple carriers (e.g., a component carrier) may be a supplementary uplink (SUL) carrier. Additionally, or alternatively, a component carrier may be a normal uplink carrier, for example associated with the serving cell of the SUL carrier (e.g., a primary serving cell). Additionally, or alternatively, one or more component carriers may be for carrier aggregation (e.g., may be regular carrier aggregation carriers).

In some examples, while some carrier aggregation deployments may improve user experience and system efficiency, carrier aggregation may increase power consumption within the wireless communications system. In some examples, to reduce power consumption the network may enable wireless communications over carriers in which synchronization signal blocks (SSBs) are not transmitted. For example, to reduce power consumption and increase resource utilization within the wireless communication system, the network may configure the communication device to perform inter-band carrier aggregation with one or multiple carriers (e.g., an SUL carrier or a regular carrier aggregation carrier) in which SSBs are not transmitted. Such carriers may be referred to as SSB-less carriers or non-anchor carriers. An SSB (e.g., synchronization signal/physical broadcast channel (SS/PBCH) blocks) may be used by the communication device during a cell search procedure (or a cell selection procedure) to obtain information (e.g., cell information, random access information). For example, the communication device may use SSBs to obtain parameters for a random access procedure, which the communication device may perform to gain access to a wireless channel (e.g., for communications with the network). In some examples, an SSB may include a primary synchronization signal (PSS), a secondary synchronization signal (SSS), and a PBCH (e.g., with one or multiple associated demodulation reference signals (DMRSs)). Additionally, or alternatively, the SSB may identify a control resource set (CORESET) for physical downlink control channel (PDCCH) scheduling of physical downlink shared channel (PDSCH) transmissions carrying a system information block (SIB).

In some examples of inter-band carrier aggregation with non-anchor carriers, the communication device may reduce power consumption by reducing the number of transmissions communicated over carriers of the primary serving cell. That is, the communication device may reduce the number of transmissions comminated over carriers in which SSBs are transmitted (e.g., anchor carriers). For example, the network may reduce anchor carrier transmissions by transmitting communications, such as random access channel (RACH) messages, over non-anchor carriers. That is, the communication device may offload RACH message (e.g., including physical random access channel (PRACH) preambles for gaining access to a wireless channel) transmissions (e.g., RACH transmissions) from an anchor carrier to other non-anchor carriers. In some examples, by offloading the RACH transmissions to non-anchor carriers, the communication device may reduce the likelihood of collisions between the RACH message transmitted by the communications device and other RACH messages transmitted by other communication devices. Accordingly, the efficiency of the wireless communications system may be increased. In some examples, the network may configure the communication device to transmit multiple RACH messages. However, in such examples, the communication device may not be capable of determining whether to use multiple non-anchor carriers for the multiple RACH.

Various aspects of the present disclosure relate to cross-carrier RACH transmissions for inter-band carrier aggregation with SSB-less (e.g., non-anchor) carriers and more specifically, to the configuration of a communication device with one or multiple rules for performing carrier aggregation with non-anchor carriers. For example, the present disclosure may provide for techniques for configuring the communication device with one or multiple rules for determining whether to transmit multiple RACH messages over a single non-anchor carrier or over multiple carriers that may include at least one non-anchor carrier.

For example, the network (e.g., one or multiple network entities) may transmit an indication of an inter-band carrier aggregation configuration to the communication device. The inter-band carrier aggregation configuration may identify a set of multiple carriers (e.g., an anchor carrier and one or multiple non-anchor carriers) for carrier aggregation communication between the communication device and the network. Additionally, or alternatively, the network may transmit an indication of a random access procedure configuration to the communication device. The random access procedure configuration may include a rule pertaining to whether RACH messages may be transmitted over the multiple carriers. In some examples, the random access procedure configuration may include a mapping of RACH occasions to one or multiple SSB indices and a repetition number that indicates a quantity of RACH message repetitions for transmission by the communication device. In some examples, the rule may indicate for the communication device to refrain from transmitting the multiple transmissions over the multiple carriers. For example, the rule may indicate for the communication device to transmit the multiple RACH messages over a single non-anchor carrier.

Additionally, or alternatively, the rule may indicate for the communication device to transmit the multiple RACH messages over the multiple carriers (e.g., including at least one non-anchor carrier). That is, the network may configure the communication device to transmit multiple RACH messages over a non-anchor carrier and the anchor carrier or one or multiple other non-anchor carriers. In some examples, the network may configure the communication device to use a common spatial filter across the multiple carriers or a different spatial filter from one carrier to another. Additionally, or alternatively, the network may configure the communication device to transmit the multiple RACH messages across the multiple carriers according to an ordering (e.g., corresponding to the mapping). In some examples, the ordering may be based on identifiers of the RACH occasions over which the RACH messages may be transmitted. For example, the communication device may transmit the multiple RACH messages sequentially (e.g., according to the RACH occasion identifiers) across the multiple carriers or in portions that may be divided (e.g., equally) between each of the multiple carriers. Additionally, or alternatively, the communication device may transmit the multiple RACH messages according to an ordering based on radio frequency bands associated with the multiple carriers.

Particular aspects of the subject matter described herein may be implemented to realize one or more of the following potential advantages. For example, the techniques employed by the described communication devices may provide benefits and enhancements to wireless communication devices operating within the network, including enabling reduced power consumption within the wireless communication system. In some examples, operations performed by the described communication devices may provide improvements to techniques for carrier aggregation and increase resource utilization within the wireless communications system. The operations performed by the described communication devices to improve techniques for carrier aggregation may include transmitting RACH message over one or multiple non-anchor carriers. In some other implementations, operations performed by the described wireless communication devices may also support improvements to user experience and higher data rates, among other benefits.

Aspects of the disclosure are initially described in the context of wireless communications systems. Aspects of the disclosure are also described in the context of a transmission scheme, timing diagrams, and a process flow. Aspects of the disclosure are further illustrated by and described with reference to apparatus diagrams, system diagrams, and flowcharts that relate to cross-carrier RACH transmissions for inter-band carrier aggregation with SSB-less (e.g., non-anchor) carriers.

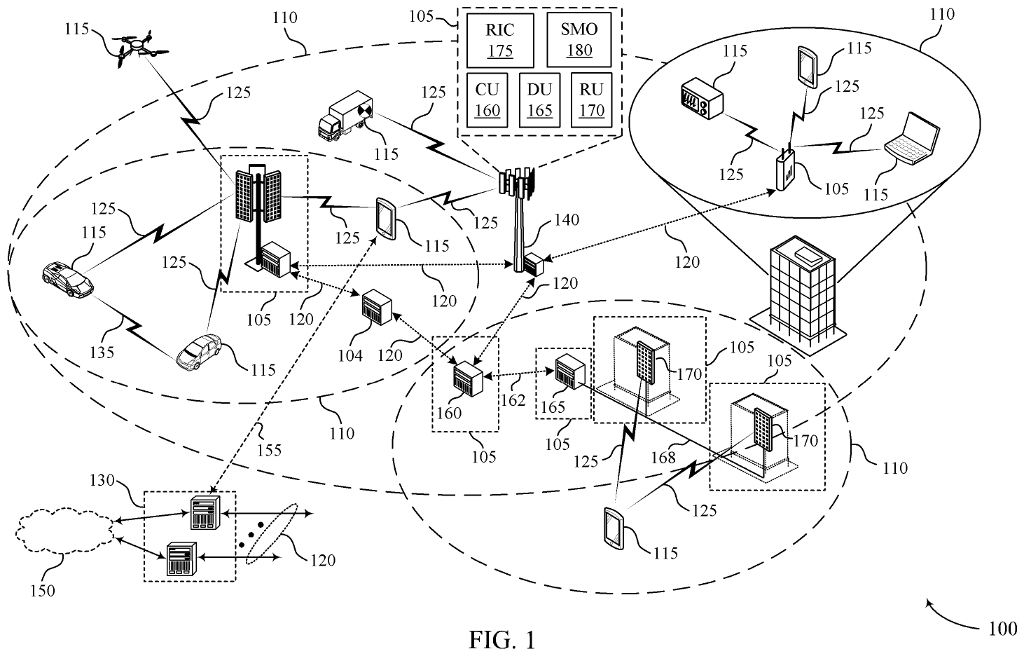

FIG. 1 illustrates an example of a wireless communications system 100 that supports cross-carrier RACH transmissions for inter-band carrier aggregation with SSB-less carriers in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cross-carrier RACH transmissions for inter-band carrier aggregation with SSB-less carriers as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support configuration of a communication device (e.g., a UE 115) with one or more rules for performing carrier aggregation with SSB-less (e.g., non-anchor) carriers. For example, the UE 115 may receive a first message that includes first information indicative of an inter-band carrier aggregation configuration. The inter-band carrier aggregation configuration may identify a set of carriers for carrier aggregation communication between the UE 115 and a network entity 105. The UE 115 may receive a second message that includes second information indicative of a random access procedure configuration. The random access procedure configuration may include a rule pertaining to whether RACH messages may be transmitted over multiple carriers, a mapping of a plurality of RACH occasions to at least one SSB index, and a repetition number that indicates a quantity of RACH message repetitions for transmission by the UE 115. The UE 115 may transmit the quantity of RACH message repetitions based on the mapping. The quantity of RACH messages may be transmitted over one carrier or over multiple carriers of the set of carriers based on the rule. As a result, the UE 115 may reduce power consumption and increase resource utilization within the wireless communications system.

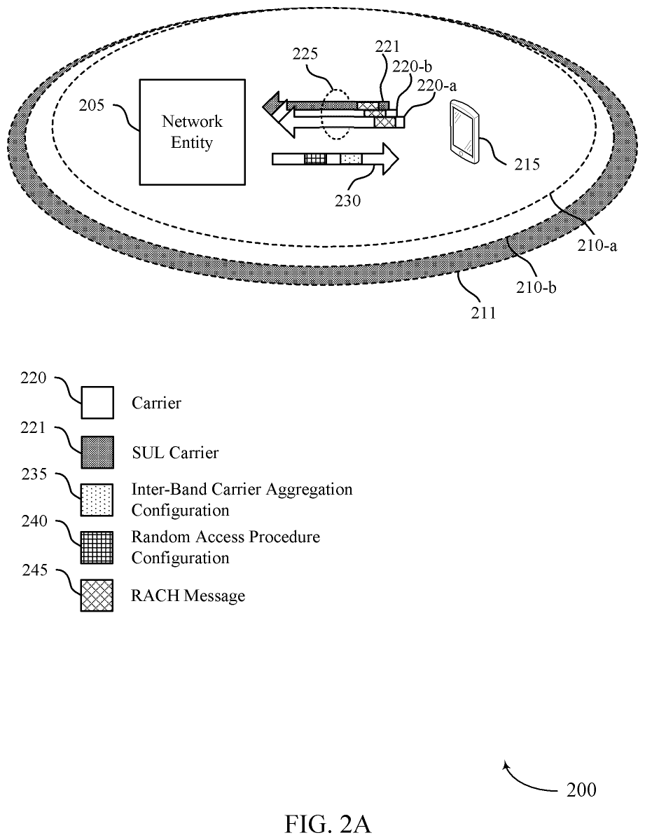

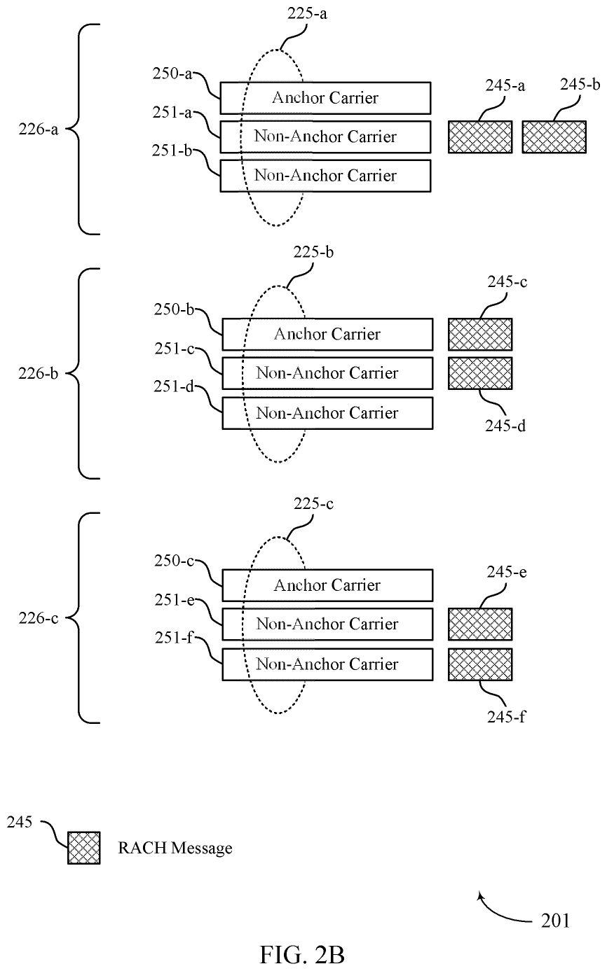

FIG. 2A illustrates an example of a wireless communications system 200 that supports cross-carrier RACH transmissions for inter-band carrier aggregation with SSB-less carriers in accordance with one or more aspects of the present disclosure. In some examples, the wireless communications system 200 may implement or be implemented by one or more aspects of the wireless communications system 100. For example, the wireless communications system 200 may include a UE 215, which may be examples of a UE 115 described with reference to FIG. 1. The wireless communications system 200 may also include a network entity 205, which may be an example of one or more network entities 105 (e.g., a CU, a DU, an RU, a base station, an IAB node, or one or more other network nodes) as described with reference to FIG. 1. The network entity 205 and the UE 215 may communicate within one or more coverage areas 210 (e.g., a coverage area 210-a or a coverage area 210-b), which may each be an example of a coverage area 110 as described with reference to FIG. 1. Additionally or alternatively the network entity 205 and the UE 215 may communicate within an SUL coverage area 211. The wireless communications system 200 may include features for improved communications between the network entity 205 and the UE 215, among other benefits.

In some examples, to increase the data capacity of the network, the wireless communications system 200 may support carrier aggregation, in which multiple carriers (e.g., component carriers) may be combined into a single data channel. For example, the UE 215 may be configured with multiple uplink carriers 220 (e.g., a carrier 220-a, a carrier 220-b) that may each be associated with (e.g., serve) a serving cell. In the example of FIG. 2, the carrier 220-a may be a primary carrier that may serve a primary cell (e.g., providing a coverage area 210-a) and carrier 220-b may be a secondary carrier that may serve a secondary cell (e.g., providing a coverage area 210-b). In some examples, the carrier 220-a may be associated with a downlink carrier 230 (e.g., a primary downlink carrier). Additionally, or alternatively, to increase uplink performance and throughput, the network may configure the UE 215 with an SUL carrier 221 that may provide the SUL coverage area 211. In some examples, the SUL carrier 221 may operate in relatively lower frequency bands (e.g., with respect to the carrier 220-a and the carrier 220-b), thereby providing increased uplink coverage for high frequency deployments. In some examples, while carrier aggregation deployments may improve user experience and system efficiency by increasing data capacity of the network, carrier aggregation may result in increased power consumption within the wireless communications system.

For example, operations performed by the network (e.g., a cellular network), such as MIMO operations performed by a RAN (e.g., the network entity 205), may be energy consuming and costly (e.g., may lead to relatively high costs for the network). As such, techniques that reduce power consumption (e.g., provide network energy savings) may be desirable for some network deployments (e.g., the adoption and expansion of cellular networks). For example, the wireless communications system 200 may support techniques that employ a network (e.g., RAN, base station) energy consumption model in which a framework for power consumption modelling and evaluation methodology (e.g., including relative energy consumption for downlink and uplink) may consider factors, such as power amplifier efficiency, number of transmitting devices (e.g., RUs), base station load, sleep states and the associated transition times, and one or more reference parameters (e.g., configurations).

Additionally, or alternatively, the wireless communications system 200 may support techniques based on (e.g., that employ) an evaluation methodology and multiple (e.g., different) key performance indicators (KPIs). In some examples of techniques that employ an evaluation methodology, system-level network energy consumption and energy savings gains may be evaluated. That is, the impact of energy saving on a network and user performance (e.g., spectral efficiency, capacity, user perceived throughput, latency, handover performance, call drop rate, initial access performance, and service level agreement assurance related KPIs), energy efficiency, UE power consumption, and complexity may be assessed (or balanced). Additionally, or alternatively, such techniques may provide an evaluation of the multiple (e.g., different KPIs).

Additionally, or alternatively, communication devices operating within the wireless communications system 200 may support techniques to improve network energy savings for (e.g., with respect to) both transmission and reception (e.g., by the communication device). For example, a communication device (e.g., the network entity 205) may support techniques that achieve increased operation efficiency for dynamic or semi-static signaling (e.g., transmissions). Additionally, or alternatively, such techniques may achieve a relatively finer granularity of the adaptation of transmissions or receptions (e.g., in the time domain, the frequency domain, the spatial domain, and the power domain) with support (e.g., feedback information and assistance information) from another communication device (e.g., the UE 215). In some examples, the exchange and coordination of information (e.g., the feedback information and the assistance information) may occur over one or multiple network interfaces (e.g., communication links).

In some examples, energy saving techniques may consider idle (e.g., relatively empty) and relatively low (or relatively average) load scenarios. For example, energy saving techniques may consider scenarios in which different loads among carriers (e.g., and neighbor cells) may be enabled. Such scenarios may include single-carrier and multi-carrier deployments, such as an urban micro cell (or small cell) deployment (e.g., in frequency range 1 (FR1) including TDD massive MIMO), beam-based scenarios (e.g., in frequency range 2 (FR2)), an urban or rural macro cell deployment (e.g., in FR1 with or without dynamic spectrum sharing (DSS)), an Evolved-Universal Terrestrial Radio Access (E-UTRA) dual connectivity scenario, or an NR dual connectivity scenario. For example, such energy saving techniques may consider a deployment over a macro cell with a primary cell capable of FDD operations, TDD operations, or massive MIMO operations (e.g., on relatively high FR1 or FR2 frequencies).

In some examples, the UE 215 (or other UEs 215 (not shown)) may be capable of accessing a network implementing such energy savings techniques (e.g., energy saving techniques that may be associated with greenfield deployments or may not be associated with greenfield deployments). In some examples, such techniques may provide energy savings for one or multiple network entities (e.g., the network entity 205, IAB nodes (not shown)). Additionally, or alternatively, such energy saving techniques may provide improvements to the coordination between the multiple network entities (e.g., between multiple RANs). Some energy saving techniques may employ carriers in which SSBs are not transmitted (e.g., SSB-less carriers). For example, the network may configure the UE 215 to perform inter-band carrier aggregation with SSB-less carriers, which may be referred to as non-anchor carriers. In some examples, the UE 215 may not be capable of using such non-anchor carriers in greenfield deployment scenarios.

In some examples of inter-band carrier aggregation with non-anchor carriers, the UE 215 may offload RACH message transmissions (e.g., RACH transmissions, PRACH transmissions) from a carrier of the primary cell that includes SSBs to one or multiple non-anchor carriers. In some examples, a carrier that includes SSBs (e.g., a carrier of the primary cell), may be referred to as an anchor carrier. As an illustrative example, the UE 215 may offload RACH transmissions from the carrier 220-a (e.g., an anchor carrier) to the carrier 220-b or the SUL carrier 221 (e.g., non-anchor carriers). In some examples, by offloading RACH transmissions from the anchor carrier to one or more non-anchor carriers, the UE 215 may reduce the likelihood of collisions between the RACH message transmitted by the UE 215 (e.g., including a PRACH preamble for gaining access to a wireless channel) and other RACH messages transmitted by other UEs 215 (not shown). In some examples, by reducing the likelihood of collisions between the RACH message transmitted by multiple UEs 215, the network may also reduce the number of RACH message re-transmissions and, as such, increase system efficiencies within the wireless communications system 200. Additionally, or alternatively, by offloading RACH transmissions from the anchor carrier to one or more non-anchor carriers, the network may extend RACH coverage throughout the wireless communications system 200.

In some examples, an SSB transmitted in one carrier may provide time and frequency synchronization for carriers that may not include SSBs. That is, an SSB of an anchor carrier may provide time and frequency synchronization for non-anchor carriers. For example, an SSB transmitted by the carrier 220-a may provide time and frequency synchronization information for the carrier 220-b and the SUL carrier 221. In some examples, non-anchor carriers may be associated with the FR1 fragmented bands, in which the bands are neighboring (e.g., at about 700 MHz, 800 MHz, 900 MHz, 1.8 GHz, 2.1 GHz, 1.9 GHz, 2 GHz, or 2.3 GHz). For example, band combinations (e.g., supported by wireless network operators) for carrier aggregation with non-anchor carriers may include: 700 MHz, 800 MHz, and 900 MHz; 1.8 GHz and 2.1 GHz; 1.9 GHz, 2 GHz, and 2.3 GHz; or 600 MHz, 1.9 GHz, and 3.5 GHz, among other band combinations.

In some examples, inter-band carrier aggregation with non-anchor carriers may support one or more features for improved coordination between multiple network entities (e.g., transmission and reception points (TRPs)) operating within the wireless communications system 200 (not shown) as well as coordination between one or multiple network entities (e.g., the network entity 205 and one or more other network entities 20 (not shown)) and the UE 215. For example, the network may define a maximum receive timing difference (MRTD) which may provide relative frame timing alignment at the UE 215. In some examples, the MRDT may account for a network relative time alignment error and a radio frequency propagation delay. Additionally, or alternatively, inter-band carrier aggregation with non-anchor carriers may provide for quasi co-location relationships between SSBs (e.g., transmitted via the anchor carrier) and signals transmitted via the non-anchor carriers. Additionally, or alternatively, inter-band carrier aggregation with non-anchor carriers may support an increased number of uplink transmissions (e.g., by the UE 215 or one or multiple other UEs 215 (not shown)). In some examples, by supporting inter-band carrier aggregation with non-anchor carriers the network may improve secondary cell activation latency by enabling secondary cell activation (or deactivation) according to traffic conditions. As such, the network may achieve power savings and improve resource utilization, for example by reducing downlink overhead.

In some examples, inter-band carrier aggregation with non-anchor carriers may reduce power consumption within the network (e.g., may provide energy savings), while providing one or more enhancements to user experience and system efficiency. In some examples, the network may configure the UE 215 to transmit multiple RACH messages (e.g., for multiple RACH transmissions). However, in such an example, the UE 215 may not be capable of determining whether to use multiple non-anchor carriers for the multiple RACH transmissions. Therefore, techniques for configuring a communication device, such as the UE 215, with one or multiple rules for performing carrier aggregation with non-anchor carriers may be desirable.

In some examples, techniques for cross-carrier RACH transmissions for inter-band carrier aggregation with non-anchor carriers, as described herein, may provide one or more enhancements to carrier aggregation by enabling the UE 215 to transmit multiple RACH messages over one or multiple non-anchor carriers. For example, the UE 215 may receive a first message that includes first information indicative of an inter-band carrier aggregation configuration 235 from the network entity 205 (e.g., via the downlink carrier 230). The inter-band carrier aggregation configuration 235 may identify a set of carriers (e.g., the carrier 220-a, the carrier 220-b, and the SUL carrier 221) for carrier aggregation communication between the UE 215 and the network entity 205. In some examples, the set of carriers may serve a virtual cell 225.

Additionally, or alternatively, the UE 215 may receive a second message that includes second information indicative of a random access procedure configuration 240. The random access procedure configuration 240 may include a rule pertaining to whether RACH messages (e.g., one or more RACH messages 245) may be transmitted over multiple carriers (e.g., two or more of the carrier 220-a, the carrier 220-b, and the SUL carrier 221). In some examples, the random access procedure configuration 240 may include a mapping of a plurality of RACH occasions to at least one SSB index (e.g., of an SSB transmitted via an anchor carrier) and a repetition number that indicates a quantity of RACH message repetitions for transmission by the UE 215. In some examples, the UE 215 may transmit the quantity of RACH message repetitions based on the mapping. Additionally, or alternatively, the UE 215 may transmit the quantity of RACH messages over one carrier or over the multiple carriers of the set of carriers based on the rule. As a result, the UE 215 may reduce power consumption and increase resource utilization within the wireless communications system.

In some examples, the UE 215 may transmit the quantity of RACH messages over one carrier or over the multiple carriers in accordance with one or multiple (e.g., different) configurations (e.g., virtual cell configurations). For example, FIG. 2B illustrates an example of a transmission scheme 201 that supports cross-carrier RACH transmissions for inter-band carrier aggregation with SSB-less carriers in accordance with one or more aspects of the present disclosure. The transmission scheme 201 may include a virtual cell 225-a, a virtual cell 225-b, and a virtual cell 225-c, which may each be examples of a virtual cell 225 as described with reference to FIG. 2A. In some examples, the transmission scheme 201 may implement or be implemented by one or more aspects of the wireless communications system 100 and the wireless communications system 200. For example, the transmission scheme 201 may by implemented by the UE 215 as described with reference to FIG. 2A.

In some examples, inter-band carrier aggregation with SSB-less carriers (e.g., non-anchor carriers) may provide for improved communications between the network and the UE 215. For example, inter-band carrier aggregation with non-anchor carriers may provide one or more enhancements for random access procedures performed over one or more radio frequency bands (e.g., FR1 and FR2) and for random access procedures perform in accordance with one or more PRACH formats (e.g., relatively short PRACH formats or otherwise suitable PRACH formats). In some examples, inter-band carrier aggregation with non-anchor carriers may provide one or more benefits (e.g., may be useful) for reducing collisions between RACH message transmissions (e.g., RACH transmissions, PRACH transmission). For example, one or multiple RACH messages transmitted during a random access procedure (e.g., a two-step random access procedure or a four-step random access procedure) may be transmitted on non-anchor carriers. In some examples, the RACH messages may be transmitted with a same beam or with different beams (e.g., for a four-step RACH procedure). Additionally, or alternatively, uplink RACH messages may be transmitted in a same uplink carrier while downlink RACH message may be transmitted in a same downlink carrier. In some examples, the uplink carrier and the downlink carrier may be different from a carrier carrying SSBs. That is, each of the uplink carrier and the downlink carrier may be either a non-anchor carrier or an anchor carrier.

For example, the network may transmit, to the UE 215, a random access procedure configuration that may include a rule pertaining to whether RACH messages (e.g., one or more RACH messages 245) may be transmitted over multiple carriers. The random access procedure configuration may be an example of the random access procedure configuration 240 as described with reference to FIG. 2A. In some examples, the rule may indicate for the UE 215 to transmit multiple RACH messages 245 over a single non-anchor carrier. In such an example, the UE 215 may transmit multiple RACH messages 245 (e.g., a RACH message 245-a and a RACH message 245-b) according to a configuration 226-a over a virtual cell 225-a (e.g., served by an anchor carrier 250-a, a non-anchor carrier 251-a, and a non-anchor carrier 251-b). That is, the UE 215 may transmit the RACH message 245-a and the RACH message 245-b via the non-anchor carrier 251-a. In some examples, the non-anchor carrier 251-a may be in a same band (or a different band) as the anchor carrier 250-a (or the non-anchor carrier 251-b). That is, for a virtual cell (e.g., the virtual cell 225-a, a virtual cell 225-b, or a virtual cell 225-c) including a carrier with SSBs (e.g., the anchor carrier 250-a, an anchor carrier 250-b, or an anchor carrier 250-c) and an SSB-less carrier (e.g., one or more of the non-anchor carriers 251), each carrier may be in a same radio frequency band or in different radio frequency bands.

In other examples, the rule may indicate for the UE 215 to transmit the multiple RACH messages 245 over multiple carriers. In such examples, the UE 215 may transmit multiple RACH messages 245 (e.g., a RACH message 245-c and a RACH message 245-d) according a configuration 226-b over a virtual cell 225-c (e.g., served by the anchor carrier 250-b, a non-anchor carrier 251-c, and a non-anchor carrier 251-d). For example, the UE 215 may transmit the RACH message 245-c via the anchor carrier 250-b and the RACH message 245-d via the non-anchor carrier 251-c. Additionally, or alternatively, if rule indicates for the UE 215 to transmit the multiple RACH messages 245 over multiple carriers, the UE 215 may transmit a RACH message 245-e and a RACH message 245-f according a configuration 226-c over a virtual cell 225-d (e.g., served by the anchor carrier 250-c, a non-anchor carrier 251-e, and a non-anchor carrier 251-f). For example, the UE 215 may transmit the RACH message 245-e via the non-anchor carrier 251-e and the RACH message 245-f via the non-anchor carrier 251-f. In some examples, by configuring the UE 215 with a rule pertaining to whether RACH messages may be transmitted over multiple carriers, the network may reduce power consumption, while providing one or more enhancements to user experience and system efficiency within a wireless communication system.

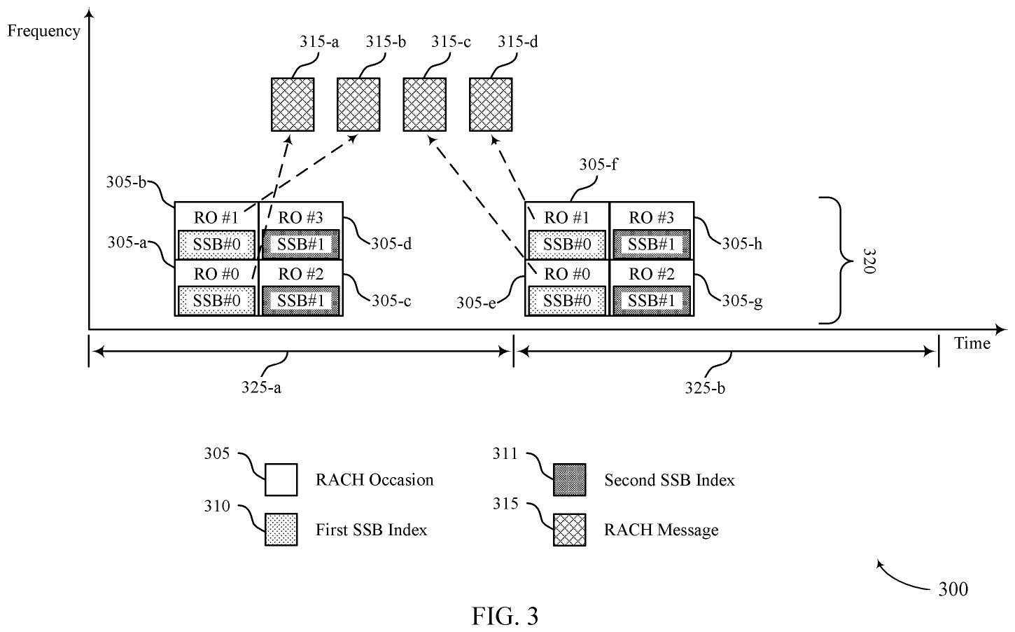

FIG. 3 illustrates an example of a timing diagram 300 that supports cross-carrier RACH transmissions for inter-band carrier aggregation with SSB-less carriers in accordance with one or more aspects of the present disclosure. In some examples, the timing diagram 300 may implement or be implemented by one or more aspects of the wireless communications system 100 and the wireless communications system 200. For example, the timing diagram 300 may be implemented by a UE 115 or a network entity 105, which may be examples of the corresponding devices as described with reference to FIGS. 1 and 2A. In the example of FIG. 3, the network entity 105 may be an example of a CU, a DU, an RU, a base station, an IAB node, or one or more other network nodes as described with reference to FIG. 1. Additionally, or alternatively, in the example of FIG. 3, SSB-less carriers may be referred to as non-anchor carriers. The timing diagram 300 may include features for improved communications between the network entity 105 and the UE 115, among other benefits.

For example, the network may configure the UE 115 transmit a RACH message (e.g., may be configured for a RACH transmission) on either a normal uplink carrier (e.g., an anchor carrier) or on an SUL carrier (or another non-anchor carrier). In such an example, the network may configure the UE 115 for multiple RACH transmissions (e.g., PRACH transmissions). As such, the network may determine to specify (e.g., indicate), to the UE 115, whether the UE 115 may use one or multiple carriers for the multiple RACH transmissions. In some examples, by indicating whether the UE 115 may use one or multiple carriers for the multiple RACH transmissions, the network may provide one or more enhancements for inter-band carrier aggregation with non-anchor carriers. For example, the network may provide one or more enhancements for inter-band carrier aggregation communications, in which the UE 115 may perform the RACH transmissions over non-anchor carriers (the SUL carrier or other non-anchor carriers) during initial access (e.g., during an initial access procedure).

In some examples, the network may indicate whether the UE 115 may use one or multiple carriers (e.g., component carriers) for the multiple RACH transmissions via a rule. For example, the network may transmit an indication of a random access procedure configuration to the UE 115 that may include a rule pertaining to whether multiple RACH messages may be transmitted over multiple carriers. The random access procedure configuration may be an example of a random access procedure configuration as described with reference to FIG. 2A. In some examples, the rule may indicate for the UE 115 to transmit RACH messages over a single non-anchor carrier. In such an example, if the UE 115 is configured with multiple RACH transmissions (e.g., configured to transmit multiple RACH messages), the UE 115 may transmit the multiple RACH messages over a single carrier 320.

In some examples, the random access procedure configuration may include a mapping of one or multiple RACH occasions 305 (e.g., for transmitting one or multiple RACH messages 315) to one or multiple SSB indices (e.g., a first SSB index 310 or a second SSB index 311). The mapping may, in some examples, be associated with (correspond to, include) one or multiple parameters. For example, the mapping may provide (e.g., establish, indicate) a relationship between a number of RACH occasions 305 and a number of SSBs according to a parameter (N). In some examples, the number of SSBs may be transmitted by an anchor carrier and used by the UE 115 for obtaining information (e.g., cell information, random access information). In the example of FIG. 3, a value of the parameter (N) may be equal to about one-half (e.g., ½, 0.5). That is, a same SSB index may be mapped to two (e.g., different) RACH occasion indices that may each corresponding to one or multiple RACH occasions 305 configured at the UE 115 for transmitting RACH messages 315. For example, the RACH occasions 305 corresponding to an index of RO #0 (e.g., a RACH occasion 305-a and a RACH occasion 305-e) and the RACH occasions corresponding to an index of RO #1 (e.g., a RACH occasion 305-b and a RACH occasion 305-f) may be mapped to a first SSB index 310 (e.g., SSB #0). Additionally, or alternatively, the RACH occasions 305 corresponding to an index of RO #2 (e.g., a RACH occasion 305-c and a RACH occasion 305-g) and the RACH occasions 305 corresponding to an index of RO #3 (e.g., a RACH occasion 305-d and a RACH occasion 305-h) may be mapped to a second SSB index 311 (e.g., SSB #1).

Additionally, or alternatively, the mapping may indicate resources for transmitting the RACH messages 315 via a parameter (M). That is, the network may indicate PRACH frequency resources to the UE 115 via the parameter (M). In some examples, the parameter (M) may correspond to (e.g., be equal to) a higher layer parameter, such as indicated via a msg1-FDM information element (IE). In the example of FIG. 3, a value of the parameter (M) may be equal to about two. That is, the configured RACH occasions 305 may occur over two resources in the frequency domain (e.g., two PRACH frequency resources). Additionally, or alternatively, the mapping may provide a number of directions in which the SSBs (e.g., corresponding to the mapped SSB indices) may be transmitted, for example by the network entity 105 over the anchor carrier. In some examples, the mapping may provide the number of directions in which the SSBs are transmitted via a parameter (N_{Tx}^{SSB}). In the example of FIG. 3, a value of the parameter (N_{Tx}^{SSB}) may be equal to about two, which may correspond to two directions (e.g., beamforming directions). That is, the SSBs used by the UE 115 (e.g., the SSB corresponding to the first SSB index 310 and the SSB corresponding to the second SSB index 311) may be transmitted by the network entity 105 in two (e.g., different) beamforming directions.

Additionally, or alternatively, the random access procedure configuration may include a repetition number that may indicate a quantity of RACH message repetitions (e.g., repetitions of RACH messages 315) for transmission by the UE 115. In the examples of FIG. 3, a value of the repetition number may be about four. That is, the random access procedure configuration may indicate for the UE 115 to transmit four RACH messages 315 (e.g., a RACH message 315-a, a RACH message 315-b, a RACH message 315-c, and a RACH message 315-d). In some examples, a single (e.g., one) association period 325 (e.g., a PRACH association period) may not support each (e.g., all) RACH message repetition (e.g., the quantity of RACH message repetitions) indicated by the random access procedure configuration. As such, the UE 115 may transmit the RACH message repetitions across multiple association periods (e.g., an association period 325-a and an association period 325-b). That is, in some examples, the RACH message repetitions may cross association periods. For example, the UE 115 may transmit a first portion of the quantity of RACH message repetitions (e.g., the RACH message 315-a and the RACH message 315-b) during the association period 325-a and a second portion of the quantity of RACH message repetitions (e.g., the RACH message 315-c and the RACH message 315-d) during the association period 325-b. In some examples, the association period 325-b may occur at a time subsequent to the association period 325-a. In some examples, by transmitting the multiple RACH messages 315 over a non-anchor carrier (e.g., the carrier 320) the UE 115 may reduce power consumption, while providing one or more enhancements to inter-band carrier aggregation communications.

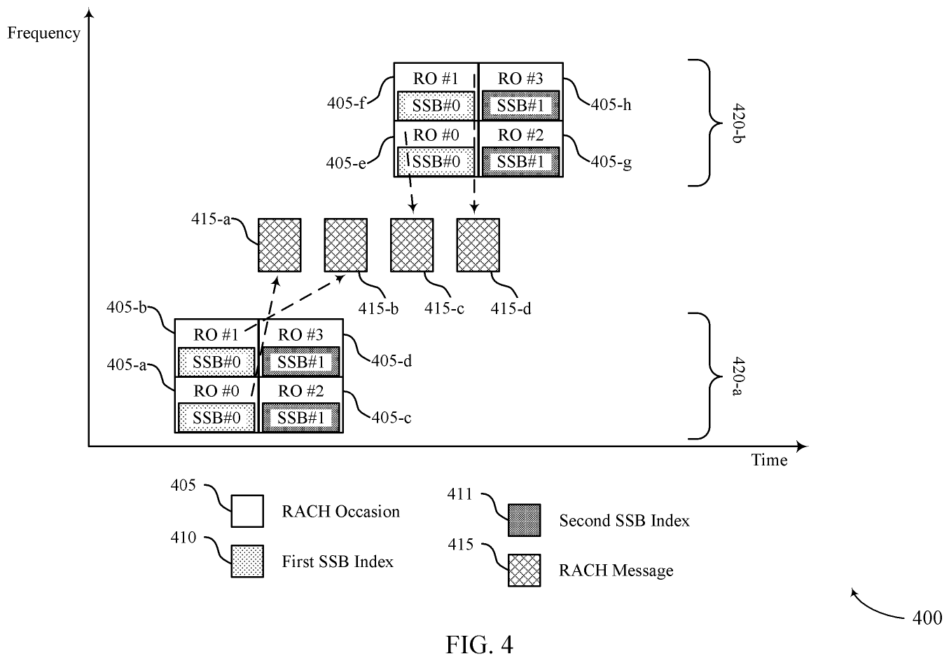

FIG. 4 illustrates an example of a timing diagram 400 that supports cross-carrier RACH transmissions for inter-band carrier aggregation with SSB-less carriers in accordance with one or more aspects of the present disclosure. In some examples, the timing diagram 400 may implement or be implemented by one or more aspects of the wireless communications system 100 and the wireless communications system 200. For example, the timing diagram 400 may be implemented by a UE 115 or a network entity 105, which may be examples of the corresponding devices as described with reference to FIGS. 1 and 2A. In the example of FIG. 4, the network entity 105 may be an example of a CU, a DU, an RU, a base station, an IAB node, or one or more other network nodes as described with reference to FIG. 1. Additionally, or alternatively, in the example of FIG. 4, SSB-less carriers may be referred to as non-anchor carriers. The timing diagram 400 may include features for improved communications between the network entity 105 and the UE 115, among other benefits.

For example, as illustrated by the example of FIG. 4, the network may indicate for the UE 115 to transmit multiple RACH messages (e.g., a RACH message 415-a, a RACH message 415-b, a RACH message 415-c, and a RACH message 415-d) over multiple carriers (e.g., component carriers). That is, the network may configure the UE 115 for multiple RACH transmissions via a rule included in a random access procedure configuration. The random access procedure configuration may be an example of a random access procedure configuration as described with reference to FIGS. 2A and 3. In some examples, the rule may indicate that the multiple carriers include at least one non-anchor carrier. In such an example, if the UE 115 is configured with multiple RACH transmissions (e.g., configured to transmit multiple RACH messages 415), the UE 115 may transmit the multiple RACH messages 415 over multiple carriers 420 (e.g., a carrier 420-a and a carrier 420-b). In some examples, by indicating for the UE 115 to transmit the multiple RACH messages 415 over multiple carriers, the network may improve PRACH performance, for example via frequency hopping (e.g., for neighboring bands, such as about 700 MHz and about 800 MHz or one or more other neighboring band combinations). Additionally, or alternatively, by indicating for the UE 115 to transmit the multiple RACH messages 415 over multiple carriers, the network may reduce a latency associated with the transmission of multiple RACH messages (e.g., performing multiple PRACH transmissions). In the example of FIG. 4, at least one of the carrier 420-a and the carrier 420-b may be a non-anchor carrier. Additionally, or alternatively, the carrier 420-a or the carrier 420-b may be an anchor carrier.

In some examples, the random access procedure configuration may include a mapping of one or multiple RACH occasions 405 to one or multiple SSB indices. In some examples, the mapping may be associated with one or multiple parameters. For example, the mapping may provide a relationship between a number of RACH occasions 405 and a number of SSBs according to a parameter (N). In the example of FIG. 4, the parameter (N) may have a value equal to about one-half (e.g., ½, 0.5). That is, a same SSB index may be mapped to two RACH occasion indices. For example, the RACH occasions 405 corresponding to an index of RO #0 (e.g., a RACH occasion 405-a and a RACH occasion 405-e) and the RACH occasions 405 corresponding to an index of RO #1 (e.g., a RACH occasion 405-b and a RACH occasion 405-f) may be mapped to a first SSB index 410 (e.g., SSB #0). Additionally, or alternatively, the RACH occasions 405 corresponding to an index of RO #2 (e.g., a RACH occasion 405-c and a RACH occasion 405-g) and the RACH occasions 405 corresponding to an index of RO #3 (e.g., a RACH occasion 405-d and a RACH occasion 405-h) may be mapped to a second SSB index 411 (e.g., SSB #1).

Additionally, or alternatively, the mapping may indicate PRACH frequency resources to the UE 115 via a parameter (M) that may be equal to about two. That is, the configured RACH occasions 405 may occur over two PRACH frequency resources. Additionally, or alternatively, the mapping may provide a number of directions in which the SSBs are transmitted via a parameter (N_{Tx}^{SSB}) that may be equal to about two. That is, the SSBs used by the UE 115 (e.g., the SSB corresponding to the first SSB index 410 and the SSB corresponding to the second SSB index 411) may be transmitted by the network entity 105 in two beamforming directions.

Additionally, or alternatively, the random access procedure configuration may include a repetition number that may be equal to about four. That is, the random access procedure configuration may indicate for the UE 115 to transmit four RACH messages 415 (e.g., the RACH message 415-a, the RACH message 415-b, the RACH message 415-c, and the RACH message 415-d). In some examples, the UE 115 may transmit a first portion of the quantity of RACH message repetitions (e.g., the RACH message 415-a and the RACH message 415-b) over a first carrier (e.g., the carrier 420-a) and a second portion of the quantity of RACH message repetitions (e.g., the RACH message 415-c and the RACH message 415-d) over a second carrier (e.g., the carrier 420-b). In the example of FIG. 4, the second portion of the quantity of RACH message repetitions may be transmitted subsequent to the first portion of the quantity of RACH message repetitions. For example, the RACH message 415-c and the RACH message 415-d may be transmitted subsequent to the RACH message 415-a and the RACH message 415-b.

In some examples, if the UE 115 is configured to transmit multiple RACH messages 415 (e.g., if the UE 115 is configured with multiple PRACH transmissions) over multiple non-anchor carriers (or multiple carries that may include at least one non-anchor carrier), the UE may perform each of the PRACH transmissions with (e.g., using) a common (e.g., same) spatial filter across the multiple carriers or a different spatial filter from one carrier to another. That is, the UE 115 may transmit the first portion of the quantity of RACH message repetitions (e.g., the RACH message 415-a and the RACH message 415-b) using a first spatial filter and the second portion of the quantity of RACH message repetitions (e.g., the RACH message 415-c and the RACH message 415-d) using a second spatial filter and the second spatial filter may be a same spatial filter as the first spatial filter or a different spatial filter from the first spatial filter.

Additionally, or alternatively, if the UE 115 is configured to transmit multiple RACH messages 415 across multiple non-anchor carriers (or multiple carries that may include at least one non-anchor carrier), the UE 115 may transmit multiple RACH messages 415 according to an order that may be based on identifiers of RACH occasions (e.g., RACH occasion indices) in which the multiple RACH messages 415 are mapped. For example, a first RACH message 415 may be transmitted in a RACH occasion 405 associated with a relatively low RACH occasion index (e.g., a lowest valid identifier or an otherwise suitable valid identifier) in a radio frequency band with a relatively low or a relatively high frequency (e.g., over a first carrier with a lowest frequency, a highest frequency, or an otherwise acceptable frequency compared to other carriers configured at the UE 115 for transmitting RACH messages 415). That is, the first RACH message 415 (e.g., the start of the RACH messages repetitions, the start of the PRACH transmission counting) may occur from a RACH occasion 405 associated with a first carrier of a radio frequency band including a relatively low frequency, a relatively high frequency, or an otherwise suitable frequency compared to other radio frequency bands configured at the UE 115 for transmitting the RACH messages 415. As an illustrative example, the UE 115 may transmit the first RACH message 415 (e.g., the RACH message 415-a) over the RACH occasion 405-a (e.g., corresponding to the index RO #0) via the carrier 420-a (e.g., a carrier of a radio frequency band including frequencies that are relatively low compared to the frequency of other configured radio frequency bands). Additionally, or alternatively, the first RACH message 415 (e.g., the start of the RACH messages repetitions, the start of the PRACH transmission counting) may occur from a RACH occasion 405 (e.g., with a lowest valid identifier or an otherwise suitable valid identifier) associated with a carrier of a radio frequency band configured by the network. That is, in some examples, the carrier 420-a may be associated with a radio frequency band indicated to the UE 115 by the network.

In some examples, by transmitting the multiple RACH messages 415 over multiple carriers (e.g., the carrier 420-a and the carrier 420-b) the UE 115 may reduce power consumption, while providing one or more enhancements to inter-band carrier aggregation communications.

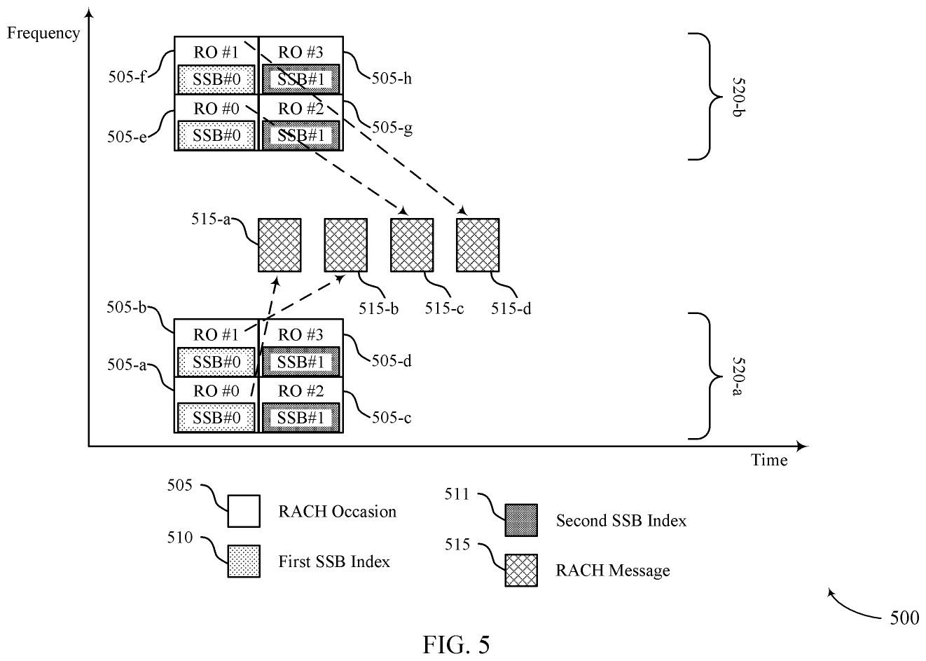

FIG. 5 illustrates an example of a timing diagram 500 that supports cross-carrier RACH transmissions for inter-band carrier aggregation with SSB-less carriers in accordance with one or more aspects of the present disclosure. In some examples, the timing diagram 500 may implement or be implemented by one or more aspects of the wireless communications system 100 and the wireless communications system 200. For example, the timing diagram 500 may be implemented by a UE 115 or a network entity 105, which may be examples of the corresponding devices as described with reference to FIGS. 1 and 2A. In the example of FIG. 5, the network entity 105 may be an example of a CU, a DU, an RU, a base station, an IAB node, or one or more other network nodes as described with reference to FIG. 1. Additionally, or alternatively, in the example of FIG. 5, SSB-less carriers may be referred to as non-anchor carriers. The timing diagram 500 may include features for improved communications between the network entity 105 and the UE 115, among other benefits.

As illustrated by the timing diagram 500, the network may indicate for the UE 115 to transmit multiple RACH messages (e.g., a RACH message 515-a, a RACH message 515-b, a RACH message 515-c, and a RACH message 515-d) over multiple carriers (e.g., component carriers). For example, the network may configure the UE 115 for multiple RACH transmissions via a rule included in a random access procedure configuration. The random access procedure configuration may be an example of a random access procedure configuration as described with reference to FIGS. 2A, 3, and 4. In some examples, the rule may indicate that the multiple carriers include at least one non-anchor carrier. In such an example, if the UE 115 is configured with multiple RACH transmissions (e.g., configured to transmit multiple RACH messages 515), the UE 115 may transmit the multiple RACH messages 515 over multiple carriers 520 (e.g., a carrier 520-a and a carrier 520-b). In the example of FIG. 5, at least one of the carrier 520-a and the carrier 520-b may be a non-anchor carrier. Additionally, or alternatively, the carrier 520-a or the carrier 520-b may be an anchor carrier.

In some examples, the random access procedure configuration may include a mapping of RACH occasions 505 (e.g., to one or multiple SSB indices) that may be associated with one or multiple parameters. For example, the mapping may provide a relationship between a number of RACH occasions 505 and a number of SSBs according to a parameter (N) that may have a value equal to about one-half (e.g., ½, 0.5). That is, a same SSB index may be mapped to two RACH occasion indices. For example, the RACH occasions 505 corresponding to an index of RO #0 (e.g., a RACH occasion 505-a and a RACH occasion 505-e) and the RACH occasions 505 corresponding to an index of RO #1 (e.g., a RACH occasion 505-b and a RACH occasion 505-f) may be mapped to a first SSB index 510 (e.g., SSB #0). Additionally, or alternatively, the RACH occasions 505 corresponding to an index of RO #2 (e.g., a RACH occasion 505-c and a RACH occasion 505-g) and the RACH occasions 505 corresponding to an index of RO #3 (e.g., a RACH occasion 505-d and a RACH occasion 505-h) may be mapped to a second SSB index 511 (e.g., SSB #1).

Additionally, or alternatively, the mapping may indicate PRACH frequency resources to the UE 115 via a parameter (M) that may be equal to about two. That is, the configured RACH occasions 505 may occur over two PRACH frequency resources. Additionally, or alternatively, the mapping may provide a number of directions in which the SSBs are transmitted via a parameter (N_{Tx}^{SSB}) that may be equal to about two. That is, the SSBs used by the UE 115 (e.g., the SSB corresponding to the first SSB index 510 and the SSB corresponding to the second SSB index 511) may be transmitted by the network entity 105 in two beamforming directions.

Additionally, or alternatively, the random access procedure configuration may include a repetition number that may be equal to about four. That is, the random access procedure configuration may indicate for the UE 115 to transmit four RACH messages 515 (e.g., the RACH message 515-a, the RACH message 515-b, the RACH message 515-c, and the RACH message 515-d). In some examples, the UE 115 may transmit a first portion of the quantity of RACH message repetitions (e.g., the RACH message 515-a and the RACH message 515-b) over a first carrier (e.g., the carrier 520-a) and a second portion of the quantity of RACH message repetitions (e.g., the RACH message 515-c and the RACH message 515-d) over a second carrier (e.g., the carrier 520-b). In the example of FIG. 5, the second portion of the quantity RACH message repetitions may be transmitted simultaneously with the first portion of the quantity of RACH message repetitions. For example, the RACH message 515-c and the RACH message 515-d may be transmitted simultaneously with the RACH message 515-a and the RACH message 515-b.

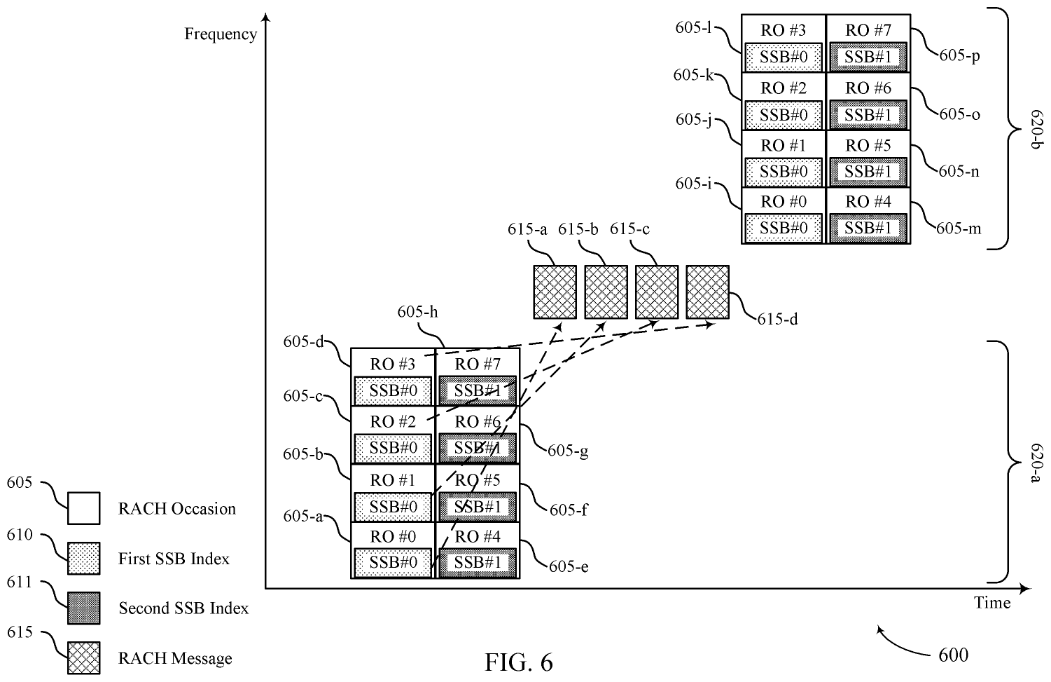

FIG. 6 illustrates an example of a timing diagram 600 that supports cross-carrier RACH transmissions for inter-band carrier aggregation with SSB-less carriers in accordance with one or more aspects of the present disclosure. In some examples, the timing diagram 600 may implement or be implemented by one or more aspects of the wireless communications system 100 and the wireless communications system 200. For example, the timing diagram 600 may be implemented by a UE 115 or a network entity 105, which may be examples of the corresponding devices as described with reference to FIGS. 1 and 2A. In the example of FIG. 6, the network entity 105 may be an example of a CU, a DU, an RU, a base station, an IAB node, or one or more other network nodes as described with reference to FIG. 1. Additionally, or alternatively, in the example of FIG. 6, SSB-less carriers may be referred to as non-anchor carriers. The timing diagram 600 may include features for improved communications between the network entity 105 and the UE 115, among other benefits.

As illustrated by the timing diagram 600, the network may indicate for the UE 115 to transmit multiple RACH messages (e.g., a RACH message 615-a, a RACH message 615-b, a RACH message 615-c, a RACH message 615-d) over multiple carriers (e.g., component carriers). For example, the network may configure the UE 115 for multiple RACH transmissions via a rule included in a random access procedure configuration. The random access procedure configuration may be an example of a random access procedure configuration as described with reference to FIGS. 2A, 3, 4, and 5. In some examples, the rule may indicate that the multiple carriers include at least one non-anchor carrier. In such an example, if the UE 115 is configured with multiple RACH transmissions (e.g., configured to transmit multiple RACH messages 615), the UE 115 may transmit the multiple RACH messages 615 over multiple carriers 620 (e.g., a carrier 620-a and a carrier 620-b). In the example of FIG. 6, at least one of the carrier 620-a and the carrier 620-b may be a non-anchor carrier. Additionally, or alternatively, the carrier 620-a or the carrier 620-b may be an anchor carrier.

In some examples, the random access procedure configuration may include a mapping of RACH occasions 605 (e.g., to one or multiple SSB indices) that may be associated with one or multiple parameters. For example, the mapping may provide a relationship between a number of RACH occasions 605 and a number of SSBs according to a parameter (N), that may have a value equal to about one-quarter (e.g., ¼, 0.25). That is, a same SSB index may be mapped to four RACH occasion indices. For example, the RACH occasions 605 corresponding to an index of RO #0 (e.g., a RACH occasion 605-a and a RACH occasion 605-i), the RACH occasions 605 corresponding to an index of RO #1 (e.g., a RACH occasion 605-b and a RACH occasion 605-j), the RACH occasions 605 corresponding to an index of RO #2 (a RACH occasion 605-c and a RACH occasion 605-k), and the RACH occasions 605 corresponding to an index of RO #3 (a RACH occasion 605-d and a RACH occasion 605-l) may be mapped to a first SSB index 610 (e.g., SSB #0). Additionally, or alternatively, the RACH occasions 605 corresponding to an index of RO #4 (e.g., a RACH occasion 605-e and a RACH occasion 605-m), the RACH occasions 605 corresponding to an index of RO #5 (e.g., a RACH occasion 605-f and a RACH occasion 605-n), the RACH occasions 605 corresponding to an index of RO #6 (a RACH occasion 605-g and a RACH occasion 605-o), and the RACH occasions 605 corresponding to an index of RO #7 (a RACH occasion 605-h and a RACH occasion 605-p) may be mapped to a second SSB index 611 (e.g., SSB #1).

Additionally, or alternatively, the mapping may indicate PRACH frequency resources to the UE 115 via a parameter (M) that may be equal to about four. That is, the configured RACH occasions 605 may occur over four PRACH frequency resources. Additionally, or alternatively, the mapping may provide a number of directions in which the SSBs are transmitted via a parameter (N_{Tx}^{SSB}) that may be equal to about two. That is, the SSBs used by the UE 115 (e.g., the SSB corresponding to the first SSB index 610 and the SSB corresponding to the second SSB index 611) may be transmitted by the network entity 105 in two beamforming directions.

Additionally, or alternatively, the random access procedure configuration may include a repetition number that may be equal to about four. That is, the random access procedure configuration may indicate for the UE 115 to transmit four RACH messages 615 (e.g., the RACH message 615-a, the RACH message 615-b, the RACH message 615-c, and the RACH message 615-d). In some examples, the UE 115 may transmit the RACH messages 615 over the multiple carriers (e.g., the carrier 620-a and the carrier 620-b) according to a transmission order. For example, the UE 115 may transmit the RACH message 615 in a sequential order (e.g., may sequentially map the RACH messages to valid RACH occasions in the carrier 620-a and the carrier 620-b). That is, the UE 115 may transmit repetitions of the RACH messages 615 over the carrier 620-a and the carrier 620-b according to a sequential ordering of the RACH messages 615. In some examples, the sequential ordering may correspond to an ordering of the RACH occasion indices. For example, the UE 115 may sequentially transmit the RACH message 615-a, the RACH message 615-b, the RACH message 615-c, and the RACH message 615-d during RACH occasions 605 according to an ordering of the corresponding RACH occasion indices (e.g., the RACH occasion index RO #0, the RACH occasion index RO #1, the RACH occasion index RO #2, the RACH occasion index RO #3). As such, the UE 115 may transmit the RACH message 615-a, the RACH message 615-b, the RACH message 615-c, and the RACH message 615-d over the carrier 620-a (e.g., a first carrier). In some examples, by transmitting the multiple RACH messages 615 over multiple carriers (e.g., the carrier 620-a and the carrier 620-b) according to the ordering, the UE 115 may improve carrier aggregation communications between the network and the UE 115.

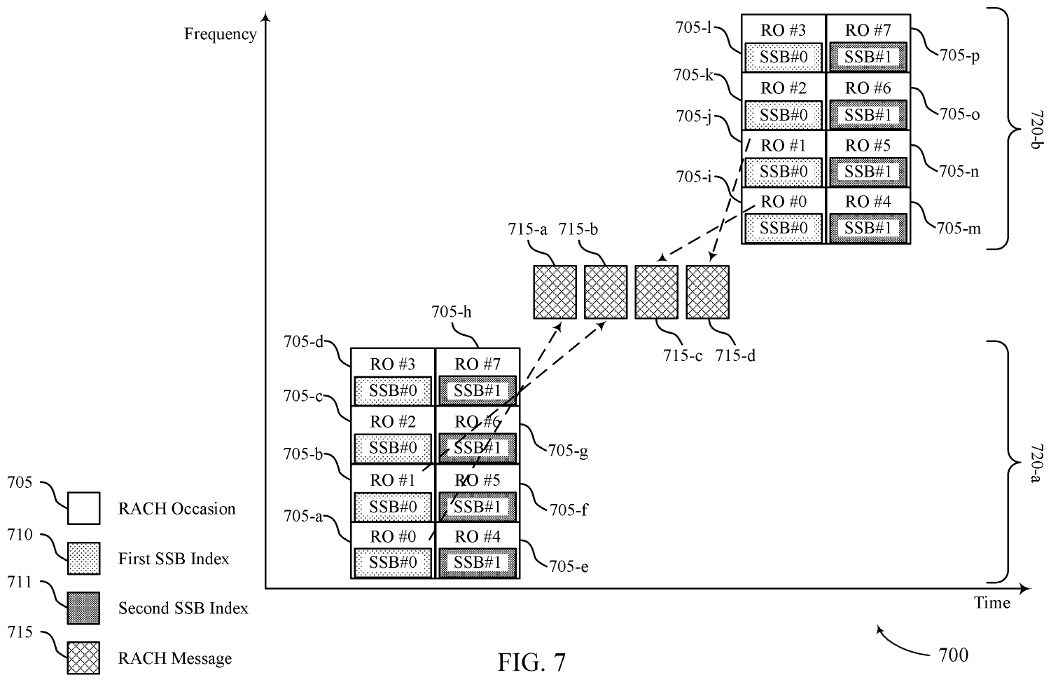

FIG. 7 illustrates an example of a timing diagram 700 that supports cross-carrier RACH transmissions for inter-band carrier aggregation with SSB-less carriers in accordance with one or more aspects of the present disclosure. In some examples, the timing diagram 700 may implement or be implemented by one or more aspects of the wireless communications system 100 and the wireless communications system 200. For example, the timing diagram 700 may be implemented by a UE 115 or a network entity 105, which may be examples of the corresponding devices as described with reference to FIGS. 1 and 2A. In the example of FIG. 7, the network entity 105 may be an example of a CU, a DU, an RU, a base station, an IAB node, or one or more other network nodes as described with reference to FIG. 1. Additionally, or alternatively, in the example of FIG. 7, SSB-less carriers may be referred to as non-anchor carriers. The timing diagram 700 may include features for improved communications between the network entity 105 and the UE 115, among other benefits.

As illustrated by the timing diagram 700, the network may indicate for the UE 115 to transmit multiple RACH messages (e.g., a RACH message 715-a, a RACH message 715-b, a RACH message 715-c, a RACH message 715-d) over multiple carriers (e.g., component carriers). For example, the network may configure the UE 115 for the multiple RACH transmissions via a rule included in a random access procedure configuration. The random access procedure configuration may be an example of a random access procedure configuration as described with reference to FIGS. 2A, 3, 4, 5, and 6. In some examples, the rule may indicate that the multiple carriers include at least one non-anchor carrier. In such an example, if the UE 115 is configured with multiple RACH transmissions (e.g., configured to transmit multiple RACH messages 715), the UE 115 may transmit the multiple RACH messages 715 over multiple carriers 720 (e.g., a carrier 720-a and a carrier 720-b). In the example of FIG. 7, at least one of the carrier 720-a and the carrier 720-b may be a non-anchor carrier. Additionally, or alternatively, the carrier 720-a or the carrier 720-b may be an anchor carrier.

In some examples, the random access procedure configuration may include a mapping of RACH occasions (e.g., to one or multiple SSB indices) that may be associated with one or multiple parameters. For example, the mapping may provide a relationship between a number of RACH occasions 705 and a number of SSBs according to a parameter (N), that may have a value equal to about one-quarter (e.g., ¼, 0.25). That is, a same SSB index may be mapped to four RACH occasion indices. For example, the RACH occasions 705 corresponding to an index of RO #0 (e.g., a RACH occasion 705-a and a RACH occasion 705-i), the RACH occasions 705 corresponding to an index of RO #1 (e.g., a RACH occasion 705-b and a RACH occasion 705-j), the RACH occasions 705 corresponding to an index of RO #2 (a RACH occasion 705-c and a RACH occasion 705-k), and the RACH occasions 705 corresponding to an index of RO #3 (a RACH occasion 705-d and a RACH occasion 705-l) may be mapped to a first SSB index 710 (e.g., SSB #0). Additionally, or alternatively, the RACH occasions 705 corresponding to an index of RO #4 (e.g., a RACH occasion 705-e and a RACH occasion 705-m), the RACH occasions 705 corresponding to an index of RO #5 (e.g., a RACH occasion 705-f and a RACH occasion 705-n), the RACH occasions 705 corresponding to an index of RO #6 (a RACH occasion 705-g and a RACH occasion 705-o), and the RACH occasions 705 corresponding to an index of RO #7 (a RACH occasion 705-h and a RACH occasion 705-p) may be mapped to a second SSB index 711 (e.g., SSB #1).

Additionally, or alternatively, the mapping may indicate PRACH frequency resources to the UE 115 via a parameter (M) that may be equal to about four. That is, the configured RACH occasions 705 may occur over four PRACH frequency resources. Additionally, or alternatively, the mapping may provide a number of directions in which the SSBs are transmitted via a parameter (N_{Tx}^{SSB}) that may be equal to about two. That is, the SSBs used by the UE 115 (e.g., the SSB corresponding to the first SSB index 710 and the SSB corresponding to the second SSB index 711) may be transmitted by the network entity 105 in two beamforming directions.

Additionally, or alternatively, the random access procedure configuration may include a repetition number that may be equal to about four. That is, the random access procedure configuration may indicate for the UE 115 to transmit four RACH messages 715 (e.g., the RACH message 715-a, the RACH message 715-b, the RACH message 715-c, and the RACH message 715-d). In some examples, the UE 115 may transmit the RACH messages 715 over the multiple carriers (e.g., the carrier 720-a and the carrier 720-b) according to a transmission order. For example, the UE 115 may transmit a subset (e.g., half of the configured repetitions) of the RACH messages 715 in a first carrier (e.g., the carrier 720-a) and transmit another subset (e.g., remaining RACH message repetitions configured for the UE) of the RACH messages 715 in a second carrier (e.g., the carrier 720-a). That is, the UE 115 may transmit a first portion of the RACH messages 715 (e.g., the RACH message 715-a and the RACH message 715-b) over the carrier 720-a and a second portion of the RACH messages 715 (e.g., the RACH message 715-c and the RACH message 715-d) over the carrier 720-b. In some examples, the UE 115 may transmit the second portion of the RACH messages 715 subsequent to the first portion of the RACH messages 715 based on the ordering.

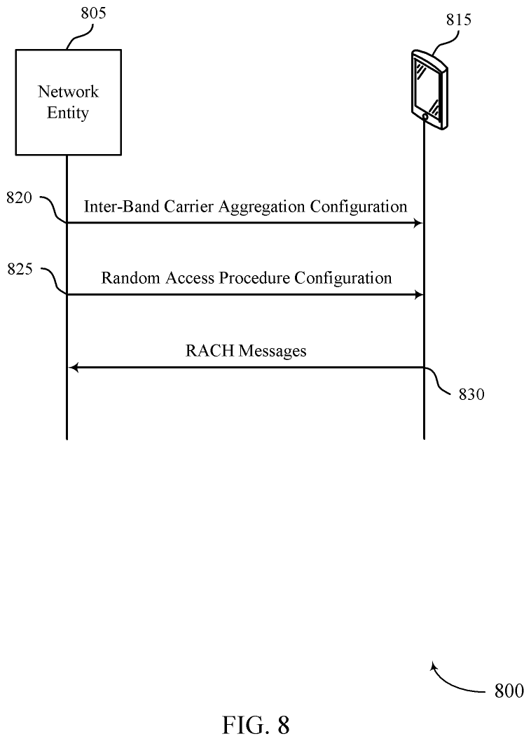

FIG. 8 illustrates an example of a process flow 800 that supports cross-carrier RACH transmissions for inter-band carrier aggregation with SSB-less carriers in accordance with one or more aspects of the present disclosure. In some examples, the process flow 800 may implement one or more aspects of wireless communications systems 100 and the wireless communications system 200. For example, the process flow 800 may include example operations associated with a network entity 805 and a UE 815, which may be examples of the corresponding devices described with reference to FIGS. 1 and 2A. In the example of FIG. 8, the network entity 805 may be an example of a CU, a DU, an RU, a base station, an IAB node, or one or more other network nodes as described with reference to FIG. 1. Additionally, or alternatively, in the example of FIG. 8, SSB-less carriers may be referred to as non-anchor carriers. The operations performed by the network entity 805 and the UE 815 may support improvements to communications between the UE 815 and the network entity 805, among other benefits.

In some examples, the network entity 805 may configure the UE 815 with one or multiple rules for performing carrier aggregation with non-anchor carriers. For example, at 820, the UE 815 may receive a first message that includes first information indicative of an inter-band carrier aggregation configuration. In some examples, the inter-band carrier aggregation configuration may be an example of an inter-band carrier aggregation configuration as described with reference to FIGS. 2A, 3, 4, 5, 6, and 7. For example, the inter-band carrier aggregation configuration may identify a set of carriers (e.g., component carriers) for carrier aggregation communication between the UE 815 and the network entity 805.

At 825, the UE 815 may receive a second message that includes second information indicative of a random access procedure configuration. In some examples, the random access procedure configuration may be an example of a random access procedure configuration as described with reference to FIGS. 2A, 3, 4, 5, 6, and 7. For example, the random access procedure configuration may include a rule pertaining to whether RACH messages may be transmitted over multiple carriers. Additionally, or alternatively, the random access procedure configuration may include a mapping of a RACH occasions to one or multiple SSB indices (e.g., each corresponding to an SSB) and a repetition number that indicates a quantity of RACH message repetitions for transmission by the UE 815.

At 830, the UE 815 may transmit RACH messages (e.g., the quantity of RACH message repetitions) based on the mapping. In some examples, the RACH messages may be transmitted over one carrier or over the multiple carriers (e.g., of the set of carriers) based on the rule. In some examples, by configuring the UE 815 with the rule pertaining to whether RACH messages may be transmitted over multiple carriers, the network entity 805 may reduce power consumption, while providing one or more enhancements to user experience and system efficiency.

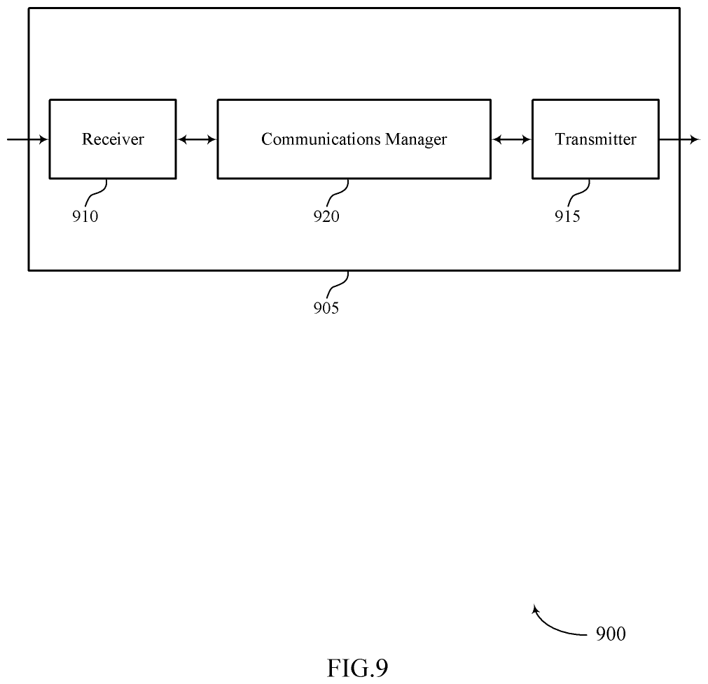

FIG. 9 shows a block diagram 900 of a device 905 that supports cross-carrier RACH transmissions for inter-band carrier aggregation with SSB-less carriers in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to cross-carrier RACH transmissions for inter-band carrier aggregation with SSB-less carriers). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to cross-carrier RACH transmissions for inter-band carrier aggregation with SSB-less carriers). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of cross-carrier RACH transmissions for inter-band carrier aggregation with SSB-less carriers (e.g., non-anchor carriers) as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE (e.g., the device 905) in accordance with examples as disclosed herein. For example, the communications manager 920 may be configured as or otherwise support a means for receiving a first message that includes first information indicative of an inter-band carrier aggregation configuration that identifies a set of carriers for carrier aggregation communication between the UE and a network entity. The communications manager 920 may be configured as or otherwise support a means for receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The communications manager 920 may be configured as or otherwise support a means for transmitting the quantity of RACH message repetitions based on the mapping, where the quantity of RACH message repetitions are transmitted over one carrier or over the multiple carriers of the set of carriers is based on the rule.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption and more efficient utilization of communication resources.

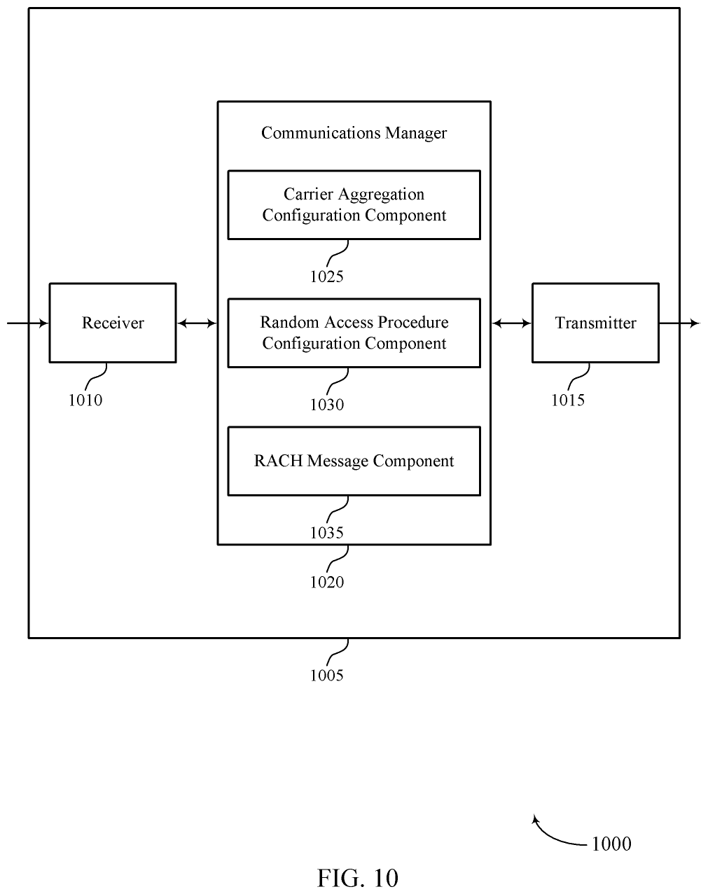

FIG. 10 shows a block diagram 1000 of a device 1005 that supports cross-carrier RACH transmissions for inter-band carrier aggregation with SSB-less carriers in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to cross-carrier RACH transmissions for inter-band carrier aggregation with SSB-less carriers). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to cross-carrier RACH transmissions for inter-band carrier aggregation with SSB-less carriers). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of cross-carrier RACH transmissions for inter-band carrier aggregation with SSB-less carriers (e.g., non-anchor carriers) as described herein. For example, the communications manager 1020 may include a carrier aggregation configuration component 1025, a random access procedure configuration component 1030, a RACH message component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE (e.g., the device 1005) in accordance with examples as disclosed herein. The carrier aggregation configuration component 1025 may be configured as or otherwise support a means for receiving a first message that includes first information indicative of an inter-band carrier aggregation configuration that identifies a set of carriers for carrier aggregation communication between the UE and a network entity. The random access procedure configuration component 1030 may be configured as or otherwise support a means for receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The RACH message component 1035 may be configured as or otherwise support a means for transmitting the quantity of RACH message repetitions based on the mapping, where the quantity of RACH message repetitions are transmitted over one carrier or over the multiple carriers of the set of carriers is based on the rule.

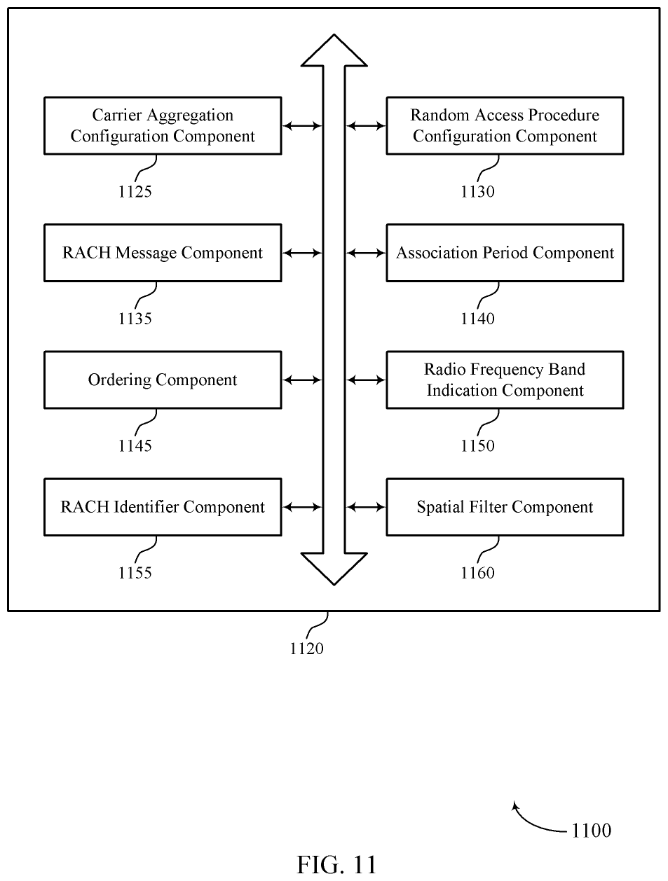

FIG. 11 shows a block diagram 1100 of a communications manager 1120 that supports cross-carrier RACH transmissions for inter-band carrier aggregation with SSB-less carriers in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of cross-carrier RACH transmissions for inter-band carrier aggregation with SSB-less carriers (e.g., non-anchor carriers) as described herein. For example, the communications manager 1120 may include a carrier aggregation configuration component 1125, a random access procedure configuration component 1130, a RACH message component 1135, an association period component 1140, an ordering component 1145, a radio frequency band indication component 1150, a RACH identifier component 1155, a spatial filter component 1160, or any combination thereof. Each of these components may communicate, directly or indirectly, with one another (e.g., via one or more buses).

The communications manager 1120 may support wireless communication at a UE (e.g., a UE 115) in accordance with examples as disclosed herein. The carrier aggregation configuration component 1125 may be configured as or otherwise support a means for receiving a first message that includes first information indicative of an inter-band carrier aggregation configuration that identifies a set of carriers for carrier aggregation communication between the UE and a network entity. The random access procedure configuration component 1130 may be configured as or otherwise support a means for receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The RACH message component 1135 may be configured as or otherwise support a means for transmitting the quantity of RACH message repetitions based on the mapping, where the quantity of RACH message repetitions are transmitted over one carrier or over the multiple carriers of the set of carriers is based on the rule.

In some examples, to support transmitting the quantity of RACH message repetitions, the RACH message component 1135 may be configured as or otherwise support a means for transmitting the quantity of RACH message repetitions over the one carrier in accordance with the rule. In some examples, the one carrier includes a non-anchor carrier.

In some examples, to support transmitting the quantity of RACH message repetitions, the association period component 1140 may be configured as or otherwise support a means for transmitting a first portion of the quantity of RACH message repetitions over the one carrier during a first association period and a second portion of the quantity of RACH message repetitions over the one carrier during a second association period, the second association period occurring subsequent to the first association period.

In some examples, to support transmitting the quantity of RACH message repetitions, the RACH message component 1135 may be configured as or otherwise support a means for transmitting the quantity of RACH message repetitions over at least two carriers of the multiple carriers in accordance with the rule. In some examples, the at least two carriers include at least one non-anchor carrier.

In some examples, the RACH message component 1135 may be configured as or otherwise support a means for transmitting a first portion of the quantity of RACH message repetitions over a first carrier of the at least two carriers and a second portion of the quantity of RACH message repetitions over a second carrier of the at least two carriers, where the second portion of the quantity of RACH message repetitions are transmitted simultaneously with or subsequent to the first portion of the quantity of RACH message repetitions.

In some examples, to support transmitting the first portion of the quantity of RACH message repetitions over the first carrier and the second portion of the quantity of RACH message repetitions over the second carrier, the spatial filter component 1160 may be configured as or otherwise support a means for transmitting the first portion of the quantity of RACH message repetitions over the first carrier using a first spatial filter and the second portion of the quantity of RACH message repetitions over the second carrier using a second spatial filter, the second spatial filter being a same spatial filter as the first spatial filter or a different spatial filter from the first spatial filter.

In some examples, to support transmitting the first portion of the quantity of RACH message repetitions over the first carrier and the second portion of the quantity of RACH message repetitions over the second carrier, the ordering component 1145 may be configured as or otherwise support a means for transmitting the second portion of the quantity of RACH message repetitions subsequent to the first portion of the quantity of RACH message repetitions based on an ordering of the quantity of RACH message repetitions, where the ordering of the quantity of RACH message repetitions corresponds to the mapping of the set of multiple RACH occasions to the at least one SSB index.

In some examples, to support transmitting the quantity of RACH message repetitions, the ordering component 1145 may be configured as or otherwise support a means for transmitting the quantity of RACH message repetitions over at least one carrier of the multiple carriers in accordance with the rule and a sequential ordering of the quantity of RACH message repetitions, where the sequential ordering of the quantity of RACH message repetitions corresponds to the mapping of the set of multiple RACH occasions to the at least one SSB index.

In some examples, to support transmitting the quantity of RACH message repetitions, the RACH message component 1135 may be configured as or otherwise support a means for transmitting a first RACH message repetition of the quantity of RACH message repetitions during a first RACH occasion and over a first carrier of the multiple carriers in accordance with the rule, where the first RACH occasion is associated with a lowest RACH identifier of a set of RACH identifiers for the set of multiple RACH occasions, and where the first carrier is associated with a lowest frequency radio frequency band or a highest frequency radio frequency band of a set of radio frequency bands for transmitting the quantity of RACH message repetitions.

In some examples, to support transmitting the quantity of RACH message repetitions, the radio frequency band indication component 1150 may be configured as or otherwise support a means for receiving a third message that includes third information indicative of a radio frequency band for transmitting RACH message repetitions of the quantity of RACH message repetitions. In some examples, to support transmitting the quantity of RACH message repetitions, the RACH identifier component 1155 may be configured as or otherwise support a means for transmitting a first RACH message repetition of the quantity of RACH message repetitions during a first RACH occasion and over a first carrier of the multiple carriers in accordance with the rule. In some examples, the first RACH occasion is associated with a lowest RACH identifier of a set of RACH identifiers for the set of multiple RACH occasions and the first carrier is associated with the radio frequency band indicated by the third message.

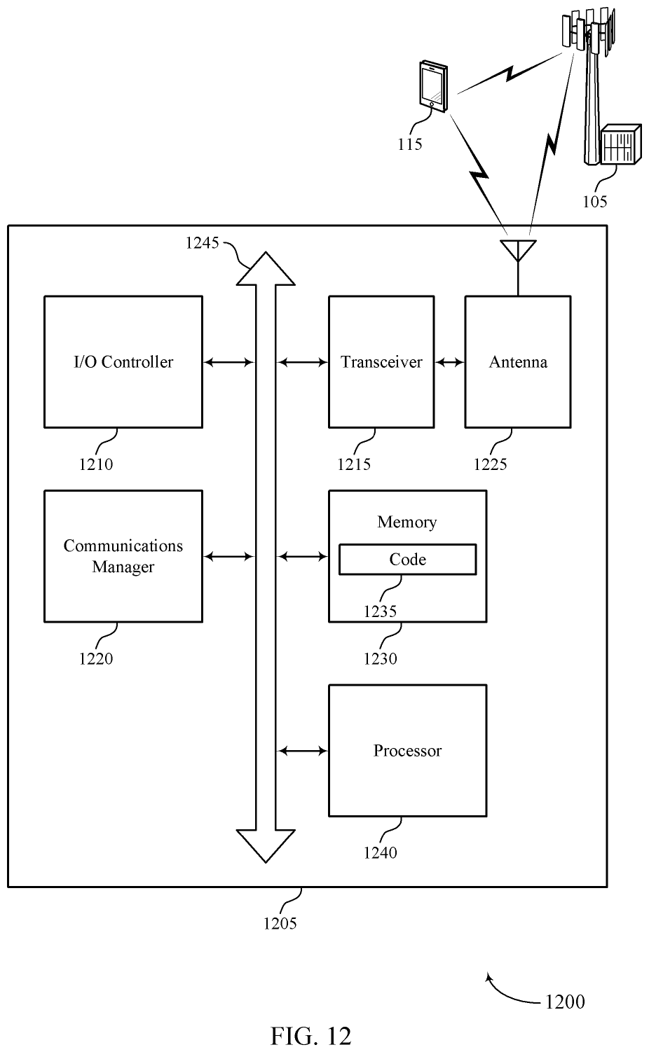

FIG. 12 shows a diagram of a system 1200 including a device 1205 that supports cross-carrier RACH transmissions for inter-band carrier aggregation with SSB-less carriers in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting cross-carrier RACH transmissions for inter-band carrier aggregation with SSB-less carriers). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE (e.g., the device 1205) in accordance with examples as disclosed herein. For example, the communications manager 1220 may be configured as or otherwise support a means for receiving a first message that includes first information indicative of an inter-band carrier aggregation configuration that identifies a set of carriers for carrier aggregation communication between the UE and a network entity. The communications manager 1220 may be configured as or otherwise support a means for receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The communications manager 1220 may be configured as or otherwise support a means for transmitting the quantity of RACH message repetitions based on the mapping, where the quantity of RACH message repetitions are transmitted over one carrier or over the multiple carriers of the set of carriers is based on the rule.

By including or configuring the communications manager 1220 in accordance with examples as described herein, the device 1205 may support techniques for reduced power consumption, more efficient utilization of communication resources, and longer battery life.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of cross-carrier RACH transmissions for inter-band carrier aggregation with SSB-less carriers (e.g., non-anchor carriers) as described herein, or the processor 1240 and the memory 1230 may be otherwise configured to perform or support such operations.

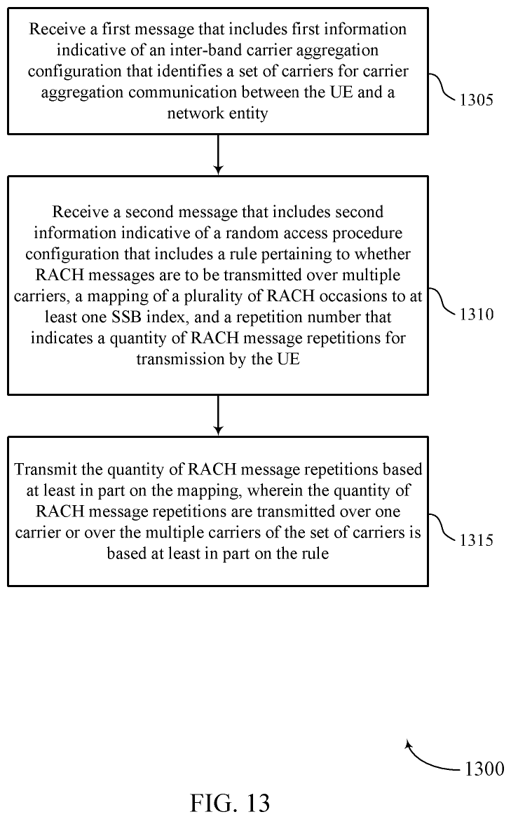

FIG. 13 shows a flowchart illustrating a method 1300 that supports cross-carrier RACH transmissions for inter-band carrier aggregation with SSB-less carriers in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving a first message that includes first information indicative of an inter-band carrier aggregation configuration that identifies a set of carriers for carrier aggregation communication between the UE and a network entity. The operations of 1305 may be performed in accordance with examples as disclosed herein. In some examples, aspects of the operations of 1305 may be performed by a carrier aggregation configuration component 1125 as described with reference to FIG. 11.

At 1310, the method may include receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The operations of 1310 may be performed in accordance with examples as disclosed herein. In some examples, aspects of the operations of 1310 may be performed by a random access procedure configuration component 1130 as described with reference to FIG. 11.

At 1315, the method may include transmitting the quantity of RACH message repetitions based on the mapping, where the quantity of RACH message repetitions are transmitted over one carrier or over the multiple carriers of the set of carriers is based on the rule. The operations of 1315 may be performed in accordance with examples as disclosed herein. In some examples, aspects of the operations of 1315 may be performed by a RACH message component 1135 as described with reference to FIG. 11.

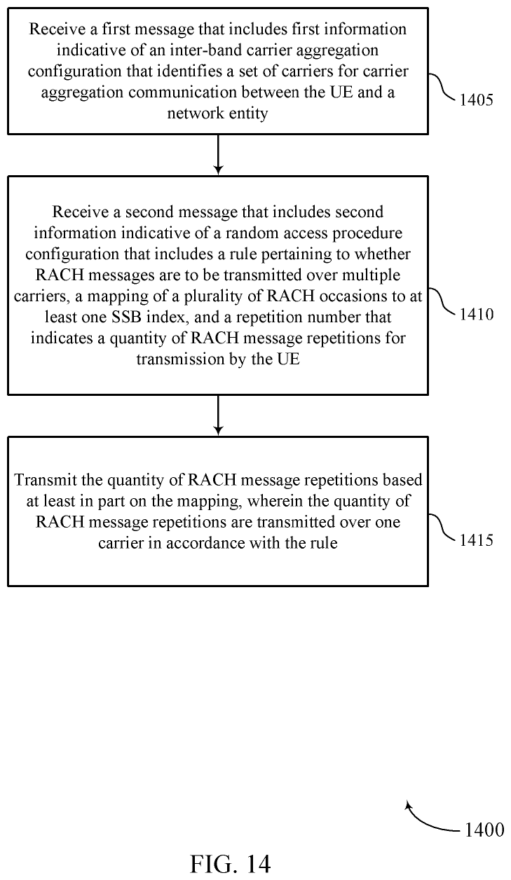

FIG. 14 shows a flowchart illustrating a method 1400 that supports cross-carrier RACH transmissions for inter-band carrier aggregation with SSB-less carriers in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving a first message that includes first information indicative of an inter-band carrier aggregation configuration that identifies a set of carriers for carrier aggregation communication between the UE and a network entity. The operations of 1405 may be performed in accordance with examples as disclosed herein. In some examples, aspects of the operations of 1405 may be performed by a carrier aggregation configuration component 1125 as described with reference to FIG. 11.

At 1410, the method may include receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The operations of 1410 may be performed in accordance with examples as disclosed herein. In some examples, aspects of the operations of 1410 may be performed by a random access procedure configuration component 1130 as described with reference to FIG. 11.

At 1415, the method may include transmitting the quantity of RACH message repetitions based on the mapping, where the quantity of RACH message repetitions are transmitted over one carrier in accordance with the rule. The operations of 1415 may be performed in accordance with examples as disclosed herein. In some examples, aspects of the operations of 1415 may be performed by a RACH message component 1135 as described with reference to FIG. 11.

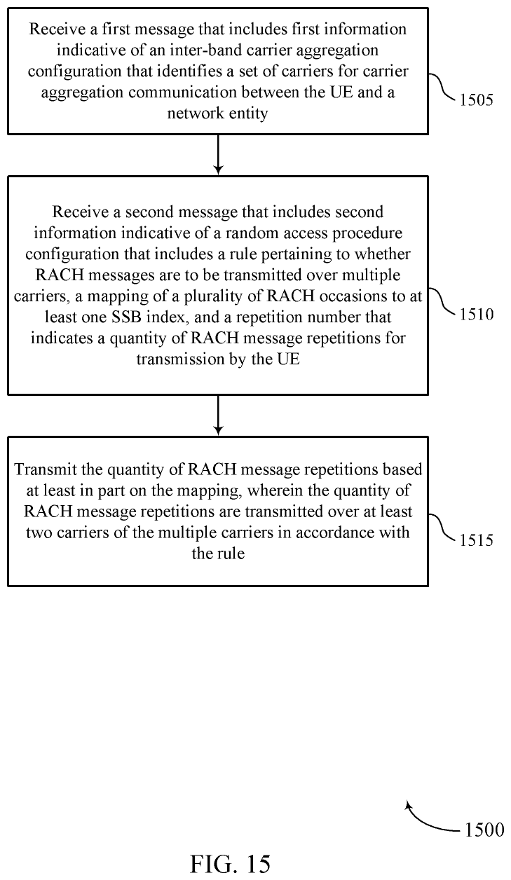

FIG. 15 shows a flowchart illustrating a method 1500 that supports cross-carrier RACH transmissions for inter-band carrier aggregation with SSB-less carriers in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving a first message that includes first information indicative of an inter-band carrier aggregation configuration that identifies a set of carriers for carrier aggregation communication between the UE and a network entity. The operations of 1505 may be performed in accordance with examples as disclosed herein. In some examples, aspects of the operations of 1505 may be performed by a carrier aggregation configuration component 1125 as described with reference to FIG. 11.

At 1510, the method may include receiving a second message that includes second information indicative of a random access procedure configuration that includes a rule pertaining to whether RACH messages are to be transmitted over multiple carriers, a mapping of a set of multiple RACH occasions to at least one SSB index, and a repetition number that indicates a quantity of RACH message repetitions for transmission by the UE. The operations of 1510 may be performed in accordance with examples as disclosed herein. In some examples, aspects of the operations of 1510 may be performed by a random access procedure configuration component 1130 as described with reference to FIG. 11.

At 1515, the method may include transmitting the quantity of RACH message repetitions based on the mapping, where the quantity of RACH message repetitions are transmitted over at least two carriers of the multiple carriers in accordance with the rule. The operations of 1515 may be performed in accordance with examples as disclosed herein. In some examples, aspects of the operations of 1515 may be performed by a RACH message component 1135 as described with reference to FIG. 11.

Aspect 1: A method for wireless communication at a UE, comprising: receiving a first message that includes first information indicative of an inter-band carrier aggregation configuration that identifies a set of carriers for carrier aggregation communication between the UE and a network entity; receiving a second message that includes second information indicative of a random access procedure configuration that includes a rule pertaining to whether RACH messages are to be transmitted over multiple carriers, a mapping of a plurality of RACH occasions to at least one SSB index, and a repetition number that indicates a quantity of RACH message repetitions for transmission by the UE; and transmitting the quantity of RACH message repetitions based at least in part on the mapping, wherein the quantity of RACH messages are transmitted over one carrier or over the multiple carriers of the set of carriers is based at least in part on the rule.

Aspect 2: The method of aspect 1, wherein transmitting the quantity of RACH message repetitions comprises: transmitting the quantity of RACH message repetitions over the one carrier in accordance with the rule.

Aspect 3: The method of aspect 2, wherein the one carrier comprises a non-anchor carrier.

Aspect 4: The method of aspect 1, wherein transmitting the quantity of RACH message repetitions comprises: transmitting a first portion of the quantity of RACH message repetitions over the one carrier during a first association period and a second portion of the quantity of RACH message repetitions over the one carrier during a second association period, the second association period occurring subsequent to the first association period.

Aspect 5: The method of aspect 1, wherein transmitting the quantity of RACH message repetitions comprises: transmitting the quantity of RACH message repetitions over at least two carriers of the multiple carriers in accordance with the rule.

Aspect 6: The method of aspect 5, wherein the at least two carriers comprise at least one non-anchor carrier.

Aspect 7: The method of any of aspects 5 through 6, further comprising: transmitting a first portion of the quantity of RACH message repetitions over a first carrier of the at least two carriers and a second portion of the quantity of RACH message repetitions over a second carrier of the at least two carriers, wherein the second portion of the quantity of RACH message repetitions are transmitted simultaneously with or subsequent to the first portion of the quantity of RACH message repetitions.

Aspect 8: The method of aspect 7, wherein transmitting the first portion of the quantity of RACH message repetitions over the first carrier and the second portion of the quantity of RACH message repetitions over the second carrier comprises: transmitting the first portion of the quantity of RACH message repetitions over the first carrier using a first spatial filter and the second portion of the quantity of RACH message repetitions over the second carrier using a second spatial filter, the second spatial filter being a same spatial filter as the first spatial filter or a different spatial filter from the first spatial filter.

Aspect 9: The method of aspect 7, wherein transmitting the first portion of the quantity of RACH message repetitions over the first carrier and the second portion of the quantity of RACH message repetitions over the second carrier comprises: transmitting the second portion of the quantity of RACH message repetitions subsequent to the first portion of the quantity of RACH message repetitions based at least in part on an ordering of the quantity of RACH message repetitions, wherein the ordering of the quantity of RACH message repetitions corresponds to the mapping of the plurality of RACH occasions to the at least one SSB index.

Aspect 10: The method of aspect 1, wherein transmitting the quantity of RACH message repetitions comprises: transmitting the quantity of RACH message repetitions over at least one carrier of the multiple carriers in accordance with the rule and a sequential ordering of the quantity of RACH message repetitions, wherein the sequential ordering of the quantity of RACH message repetitions corresponds to the mapping of the plurality of RACH occasions to the at least one SSB index.

Aspect 11: The method of aspect 1, wherein transmitting the quantity of RACH message repetitions comprises: transmitting a first RACH message repetition of the quantity of RACH message repetitions during a first RACH occasion and over a first carrier of the multiple carriers in accordance with the rule, wherein the first RACH occasion is associated with a lowest RACH identifier of a set of RACH identifiers for the plurality of RACH occasions, and wherein the first carrier is associated with a lowest frequency radio frequency band or a highest frequency radio frequency band of a set of radio frequency bands for transmitting the quantity of RACH message repetitions.

Aspect 12: The method of aspect 1, wherein transmitting the quantity of RACH message repetitions comprises: receiving a third message that includes third information indicative of a radio frequency band for transmitting RACH message repetitions of the quantity of RACH message repetitions; and transmitting a first RACH message repetition of the quantity of RACH message repetitions during a first RACH occasion and over a first carrier of the multiple carriers in accordance with the rule, wherein the first RACH occasion is associated with a lowest RACH identifier of a set of RACH identifiers for the plurality of RACH occasions, and wherein the first carrier is associated with the radio frequency band indicated by the third message.

Aspect 13: An apparatus for wireless communication at a UE, comprising a processor; memory coupled with the processor; and instructions stored in the memory and executable by the processor to cause the apparatus to perform a method of any of aspects 1 through 12.

Aspect 14: An apparatus for wireless communication, comprising at least one means for performing a method of any of aspects 1 through 12.

Aspect 15: A non-transitory computer-readable medium storing code for wireless communication at a UE, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first message that includes first information indicative of an inter-band carrier aggregation configuration that identifies a set of carriers for carrier aggregation communication between the UE and a network entity;
receiving a second message that includes second information indicative of a random access procedure configuration that includes a rule pertaining to whether random access channel messages are to be transmitted over multiple carriers, a mapping of a plurality of random access channel occasions to at least one synchronization signal block index, and a repetition number that indicates a quantity of random access channel message repetitions for transmission by the UE; and
transmitting the quantity of random access channel message repetitions based at least in part on the mapping, wherein the quantity of random access channel message repetitions are transmitted over one carrier or over the multiple carriers of the set of carriers is based at least in part on the rule.

2. The method of claim 1, wherein transmitting the quantity of random access channel message repetitions comprises:
transmitting the quantity of random access channel message repetitions over the one carrier in accordance with the rule.

3. The method of claim 2, wherein the one carrier comprises a non-anchor carrier.

4. The method of claim 1, wherein transmitting the quantity of random access channel message repetitions comprises:
transmitting a first portion of the quantity of random access channel message repetitions over the one carrier during a first association period and a second portion of the quantity of random access channel message repetitions over the one carrier during a second association period, the second association period occurring subsequent to the first association period.

5. The method of claim 1, wherein transmitting the quantity of random access channel message repetitions comprises:
transmitting the quantity of random access channel message repetitions over at least two carriers of the multiple carriers in accordance with the rule.

6. The method of claim 5, wherein the at least two carriers comprise at least one non-anchor carrier.

7. The method of claim 5, further comprising:
transmitting a first portion of the quantity of random access channel message repetitions over a first cater of the at least two carriers and a second portion of the quantity of random access channel message repetitions over a second carrier of the at least two carriers, wherein the second portion of the quantity of random access channel message repetitions are transmitted simultaneously with or subsequent to the first portion of the quantity of random access channel message repetitions.

8. The method of claim 7, wherein transmitting the first portion of the quantity of random access channel message repetitions over the first cater and the second portion of the quantity of random access channel message repetitions over the second carrier comprises:
transmitting the first portion of the quantity of random access channel message repetitions over the first carrier using a first spatial filter and the second portion of the quantity of random access channel message repetitions over the second carrier using a second spatial filter, the second spatial filter being a same spatial filter as the first spatial filter or a different spatial filter from the first spatial filter.

9. The method of claim 7, wherein transmitting the first portion of the quantity of random access channel message repetitions over the first carrier and the second portion of the quantity of random access channel message repetitions over the second carrier comprises:
transmitting the second portion of the quantity of random access channel message repetitions subsequent to the first portion of the quantity of random access channel message repetitions based at least in part on an ordering of the quantity of random access channel message repetitions, wherein the ordering of the quantity of random access channel message repetitions corresponds to the mapping of the plurality of random access channel occasions to the at least one synchronization signal block index.

10. The method of claim 1, wherein transmitting the quantity of random access channel message repetitions comprises:
transmitting the quantity of random access channel message repetitions over at least one carrier of the multiple carriers in accordance with the rule and a sequential ordering of the quantity of random access channel message repetitions, wherein the sequential ordering of the quantity of random access channel message repetitions corresponds to the mapping of the plurality of random access channel occasions to the at least one synchronization signal block index.

11. The method of claim 1, wherein transmitting the quantity of random access channel message repetitions comprises:
transmitting a first random access channel message repetition of the quantity of random access channel message repetitions during a first random access channel occasion and over a first carrier of the multiple carriers in accordance with the rule, wherein the first random access channel occasion is associated with a lowest random access channel identifier of a set of random access channel identifiers for the plurality of random access channel occasions, and wherein the first carrier is associated with a lowest frequency radio frequency band or a highest frequency radio frequency band of a set of radio frequency bands for transmitting the quantity of random access channel message repetitions.

12. The method of claim 1, wherein transmitting the quantity of random access channel message repetitions comprises:
receiving a third message that includes third information indicative of a radio frequency band for transmitting random access channel message repetitions of the quantity of random access channel message repetitions; and
transmitting a first random access channel message repetition of the quantity of random access channel message repetitions during a first random access channel occasion and over a first carrier of the multiple carriers in accordance with the rule, wherein the first random access channel occasion is associated with a lowest random access channel identifier of a set of random access channel identifiers for the plurality of random access channel occasions, and wherein the first carrier is associated with the radio frequency band indicated by the third message.

13. A user equipment (UE) for wireless communication, comprising:
a processor;
memory coupled with the processor; and
instructions stored in the memory and executable by the processor to cause the UE to:
receive a first message that includes first information indicative of an inter-band carrier aggregation configuration that identifies a set of carriers for carrier aggregation communication between the UE and a network entity;
receive a second message that includes second information indicative of a random access procedure configuration that includes a rule pertaining to whether random access channel messages are to be transmitted over multiple carriers, a mapping of a plurality of random access channel occasions to at least one synchronization signal block index, and a repetition number that indicates a quantity of random access channel message repetitions for transmission by the UE; and
transmit the quantity of random access channel message repetitions based at least in part on the mapping, wherein the quantity of random access channel message repetitions are transmitted over one carrier or over the multiple carriers of the set of carriers is based at least in part on the rule.

14. The UE of claim 13, wherein the instructions to transmit the quantity of random access channel message repetitions are executable by the processor to cause the UE to:
transmit the quantity of random access channel message repetitions over the one carrier in accordance with the rule.

15. The UE of claim 14, wherein the one carrier comprises a non-anchor carrier.

16. The UE of claim 13, wherein the instructions to transmit the quantity of random access channel message repetitions are executable by the processor to cause the UE to:
transmit a first portion of the quantity of random access channel message repetitions over the one carrier during a first association period and a second portion of the quantity of random access channel message repetitions over the one carrier during a second association period, the second association period occurring subsequent to the first association period.

17. The UE of claim 13, wherein the instructions to transmit the quantity of random access channel message repetitions are executable by the processor to cause the UE to:
transmit the quantity of random access channel message repetitions over at least two carriers of the multiple carriers in accordance with the rule.

18. The UE of claim 17, wherein:
the at least two carriers comprise at least one non-anchor carrier.

19. The UE of claim 17, wherein the instructions are further executable by the processor to cause the UE to:
transmit a first portion of the quantity of random access channel message repetitions over a first carrier of the at least two carriers and a second portion of the quantity of random access channel message repetitions over a second carrier of the at least two carriers, wherein the second portion of the quantity of random access channel message repetitions are transmitted simultaneously with or subsequent to the first portion of the quantity of random access channel message repetitions.

20. The UE of claim 19, wherein the instructions to transmit the first portion of the quantity of random access channel message repetitions over the first carrier and the second portion of the quantity of random access channel message repetitions over the second carrier are executable by the processor to cause the UE to:
transmit the first portion of the quantity of random access channel message repetitions over the first carrier using a first spatial filter and the second portion of the quantity of random access channel message repetitions over the second carrier using a second spatial filter, the second spatial filter being a same spatial filter as the first spatial filter or a different spatial filter from the first spatial filter.

21. The UE of claim 19, wherein the instructions to transmit the first portion of the quantity of random access channel message repetitions over the first carrier and the second portion of the quantity of random access channel message repetitions over the second carrier are executable by the processor to cause the UE to:
transmit the second portion of the quantity of random access channel message repetitions subsequent to the first portion of the quantity of random access channel message repetitions based at least in part on an ordering of the quantity of random access channel message repetitions, wherein the ordering of the quantity of random access channel message repetitions corresponds to the mapping of the plurality of random access channel occasions to the at least one synchronization signal block index.

22. The UE of claim 13, wherein the instructions to transmit the quantity of random access channel message repetitions are executable by the processor to cause the UE to:
transmit the quantity of random access channel message repetitions over at least one carrier of the multiple carriers in accordance with the rule and a sequential ordering of the quantity of random access channel message repetitions, wherein the sequential ordering of the quantity of random access channel message repetitions corresponds to the mapping of the plurality of random access channel occasions to the at least one synchronization signal block index.

23. The UE of claim 13, wherein the instructions to transmit the quantity of random access channel message repetitions are executable by the processor to cause the UE to:
transmit a first random access channel message repetition of the quantity of random access channel message repetitions during a first random access channel occasion and over a first carrier of the multiple carriers in accordance with the rule, wherein the first random access channel occasion is associated with a lowest random access channel identifier of a set of random access channel identifiers for the plurality of random access channel occasions, and wherein the first carrier is associated with a lowest frequency radio frequency band or a highest frequency radio frequency band of a set of radio frequency bands for transmitting the quantity of random access channel message repetitions.

24. The UE of claim 13, wherein the instructions to transmit the quantity of random access channel message repetitions are executable by the processor to cause the UE to:
receive a third message that includes third information indicative of a radio frequency band for transmitting random access channel message repetitions of the quantity of random access channel message repetitions; and
transmit a first random access channel message repetition of the quantity of random access channel message repetitions during a first random access channel occasion and over a first carrier of the multiple carriers in accordance with the rule, wherein the first random access channel occasion is associated with a lowest random access channel identifier of a set of random access channel identifiers for the plurality of random access channel occasions, and wherein the first carrier is associated with the radio frequency band indicated by the third message.

25. A user equipment (UE) for wireless communication, comprising:
means for receiving a first message that includes first information indicative of an inter-band carrier aggregation configuration that identifies a set of carriers for carrier aggregation communication between the UE and a network entity;
means for receiving a second message that includes second information indicative of a random access procedure configuration that includes a rule pertaining to whether random access channel messages are to be transmitted over multiple carriers, a mapping of a plurality of random access channel occasions to at least one synchronization signal block index, and a repetition number that indicates a quantity of random access channel message repetitions for transmission by the UE; and
means for transmitting the quantity of random access channel message repetitions based at least in part on the mapping, wherein the quantity of random access channel message repetitions are transmitted over one carrier or over the multiple carriers of the set of carriers is based at least in part on the rule.

26. The UE of claim 25, wherein the means for transmitting the quantity of random access channel message repetitions comprise:
means for transmitting the quantity of random access channel message repetitions over the one carrier in accordance with the rule.

27. The UE of claim 25, wherein the means for transmitting the quantity of random access channel message repetitions comprise:
means for transmitting the quantity of random access channel message repetitions over at least two carriers of the multiple carriers in accordance with the rule.

28. A non-transitory computer-readable medium storing code for wireless communication, the code comprising instructions executable by a processor to:
receive a first message that includes first information indicative of an inter-band carrier aggregation configuration that identifies a set of carriers for carrier aggregation communication between a user equipment (UE) and a network entity;
receive a second message that includes second information indicative of a random access procedure configuration that includes a rule pertaining to whether random access channel messages are to be transmitted over multiple carriers, a mapping of a plurality of random access channel occasions to at least one synchronization signal block index, and a repetition number that indicates a quantity of random access channel message repetitions for transmission by the UE; and
transmit the quantity of random access channel message repetitions based at least in part on the mapping, wherein the quantity of random access channel message repetitions are transmitted over one carrier or over the multiple carriers of the set of carriers is based at least in part on the rule.

29. The non-transitory computer-readable medium of claim 28, wherein the instructions to transmit the quantity of random access channel message repetitions are executable by the processor to:
transmit the quantity of random access channel message repetitions over the one carrier in accordance with the rule.

30. The non-transitory computer-readable medium of claim 28, wherein the instructions to transmit the quantity of random access channel message repetitions are executable by the processor to:
transmit the quantity of random access channel message repetitions over at least two carriers of the multiple carriers in accordance with the rule.
